(19) United States
(12) Patent Application Publication
(10) Pub. No.: US 2024/0289639 A1
(43) Pub. Date: Aug. 29, 2024

(54) METHODS AND APPARATUS TO AUTOMATICALLY TUNE REINFORCEMENT LEARNING HYPERPARAMETERS ASSOCIATED WITH AGENT BEHAVIOR

(71) Applicant: Substrate Artificial Intelligence SA, Madrid (ES)

(72) Inventor: James Brennan WORTH, Castellón de la Plana (ES)

(21) Appl. No.: 18/113,350

(22) Filed: Feb. 23, 2023

(51) Int. Cl. G06N 3/0985

(52) U.S. Cl. CPC G06N 3/0985

(57) ABSTRACT

A method includes receiving information associated with interactions of an agent with an environment according to a policy defined based on a plurality of hyperparameters. The interactions can include states associated with the environment and actions associated with each state. The method includes receiving an indication of a target state to be achieved by the agent in the environment and determining an indication of a set of current values. Each current value from the set of current values is associated with a different hyperparameter from the plurality of hyperparameters. The plurality of hyperparameters can impact the agent's interactions with the environment. The method includes modifying the policy by changing a current value from the set of current values based on the information associated with the interactions of the agent with the environment and the indication of the target state to increase a likelihood of the agent achieving the target state.

### BACKGROUND

The embodiments described herein relate to methods and apparatus for automated tuning of parameters associated with learning using machine learning.

In the recent past, technological advancements in various management systems have increasingly used computational methods based on machine learning. Some implementations of such management systems use digital learning agents that operate under set rules and manipulate one or more systems to navigate a given environment and/or maximize identified rewards. While such learning agents have been tested in artificially created environments, implementation of learning agents in real world environments has been challenging due to inability of the agents to face dynamic needs of the environment.

Accordingly, there exists a need to automatically adapt a behavior of a learning agent to optimize and/or improve performance in an environment, including real world environments.

### SUMMARY

In some embodiments, a method includes receiving information associated with interactions of an agent with an environment according to a policy defined based on a plurality of hyperparameters. The interactions can include states associated with the environment and actions associated with each state from the states. The method includes receiving an indication of a target state to be achieved by the agent in the environment. The method further includes determining an indication of a set of current values. Each current value from the set of current values is associated with a different hyperparameter from the plurality of hyperparameters. The plurality of hyperparameters is configured to impact the agent's interactions with the environment. The method further includes modifying the policy by automatically changing at least one current value from the set of current values based on the information associated with the interactions of the agent with the environment and the indication of the target state to increase a likelihood of the agent achieving the target state.

In some embodiments, an apparatus, includes a memory and a hardware processor operatively coupled to the memory. The hardware processor is configured to determine a first measure of performance associated with interactions of an agent with an environment and determine a second measure of performance associated with interactions of the agent with the environment. The first measure of performance is based on the agent's interactions with the environment according to a first policy and the second measure of performance is based on the agent's interactions with the environment according to a second policy different than the first policy. The hardware processor is configured to calculate a difference between the first measure of performance and the second measure of performance. Based on the difference between the first measure of performance and the second measure of performance, the hardware processor is configured to automatically change at least one current value from a set of current values. The set of current values are such that each current value from the set of current values is associated with a different hyperparameter from a plurality of hyperparameters, and the hyperparameters are configured to impact the agent's interactions with the environment.

Embodiments disclosed include a non-transitory processor-readable medium storing code representing instructions to be executed by a processor. The instructions include code to cause the processor to receive data associated with interactions between a first agent and a first environment. The data includes a context associated with the first environment. The instructions include code to cause the processor to receive information about a second environment. The information includes a goal that is desired to be achieved in the second environment. The instructions further include code to cause the processor to implement, using a machine learning model, a second agent configured to interact with the second environment according to a policy. The instructions include code to cause the processor to receive information associated with interactions of the second agent with the second environment. The information includes a context of the second environment and one or more measures of performance associated with the interactions of the second agent with the second environment. The instructions further include code to cause the processor to modify the policy, based on the data associated with the interactions between the first agent and the first environment, by changing at least one current value from a set of current values. Each current value from the set of current values is associated with a different hyperparameter from a plurality of hyperparameters. The plurality of hyperparameters are configured to impact the second agent's interactions with the second environment.

### BRIEF DESCRIPTION OF THE DRAWINGS

FIG. 1 is a schematic illustration of an agent management (AM) system, according to an embodiment.

FIG. 2A a schematic representation of interactions between an agent included in an AM system and an environment in which the agent performs actions to implement an identified task, according to an embodiment.

FIG. 2B is an illustration of an equation representative of an algorithm used to implement an agent using an AM system, according to an embodiment.

FIG. 3A is a schematic illustration of an environment in which an agent may be deployed to navigate and maximize and/or improve rewards, using an AM system, according to an embodiment.

FIG. 3B is an illustration of improved strategies that may be available to an agent to perform actions in an environment using an AM system, according to an embodiment.

FIG. 3C is a schematic illustration of changes in a hyperparameter epsilon that an agent might use to navigate an environment using an AM system, according to an embodiment.

FIG. 4 is a schematic representation of an agent management device included in an AM system, according to an embodiment.

FIG. 5 is a flowchart describing a method of managing an agent performing a task in an AM system, according to an embodiment.

FIG. 6 is a flowchart describing a method of managing an agent performing a task in an AM system, according to an embodiment.

FIG. 7 is a schematic representation of states and state changes assumed by one or more agents implemented by an AM system, according to an embodiment.

FIG. 8 is a schematic representation of a sequence of state changes including options assumed by agents included in an AM system, according to an embodiment.

FIG. 9 is a schematic representation of interaction between an agent implemented by an AM system using hierarchical models and an external world environment, according to an embodiment.

FIG. 10 is a schematic representation of a flow of information in an AM system implementing agents and temporal abstractions to learn relationships in a world environment, according to an embodiment.

FIG. 11 is a schematic representation of a flow of information in an AM system implementing generation of synthetic states, according to an embodiment.

FIGS. 12A and 12B are graphical representations of environments in which an agent can be implemented using an AM system, according to an embodiment.

FIG. 13 illustrates graphical representations of example states and trajectories, including synthetic states and synthetic trajectories, in an environment, in which an agent can be implemented using an AM system, according to an embodiment.

### DETAILED DESCRIPTION

In some embodiments, a method includes receiving information associated with interactions of an agent with an environment according to a policy defined based on a plurality of hyperparameters. The interactions can include states associated with the environment and actions associated with each state from the states. The method includes receiving an indication of a target state to be achieved by the agent in the environment. The method further includes determining an indication of a set of current values. Each current value from the set of current values is associated with a different hyperparameter from the plurality of hyperparameters. The plurality of hyperparameters is configured to impact the agent's interactions with the environment. The method further includes modifying the policy by automatically changing at least one current value from the set of current values based on the information associated with the interactions of the agent with the environment and the indication of the target state to increase a likelihood of the agent achieving the target state.

Disclosed embodiments include a non-transitory processor-readable medium storing code representing instructions to be executed by a processor. The instructions include code to cause the processor to receive data associated with interactions between a first agent and a first environment. The data includes a context associated with the first environment. The instructions include code to cause the processor to receive information about a second environment. The information includes a goal that is desired to be achieved in the second environment. The instructions further include code to cause the processor to implement, using a machine learning model, a second agent configured to interact with the second environment according to a policy. The instructions include code to cause the processor to receive information associated with interactions of the second agent with the second environment. The information includes a context of the second environment and one or more measures of performance associated with the interactions of the second agent with the second environment. The instructions further include code to cause the processor to modify the policy, based on the data associated with the interactions between the first agent and the first environment, by changing at least one current value from a set of current values. Each current value from the set of current values is associated with a different hyperparameter from a plurality of hyperparameters. The plurality of hyperparameters is configured to impact the second agent's interactions with the second environment.

Disclosed embodiments include an apparatus including a memory and a hardware processor operatively coupled to the memory. The hardware processor is configured to determine a first measure of performance associated with interactions of an agent with an environment and determine a second measure of performance associated with interactions of the agent with the environment. The first measure of performance is based on the agent's interactions with the environment according to a first policy and the second measure of performance is based on the agent's interactions with the environment according to a second policy different than the first policy. The hardware processor is configured to calculate a difference between the first measure of performance and the second measure of performance. Based on the difference between the first measure of performance and the second measure of performance, the hardware processor is configured to automatically change at least one current value from a set of current values. The set of current values are such that each current value from the set of current values is associated with a different hyperparameter from a plurality of hyperparameters, and the hyperparameters are configured to impact the agent's interactions with the environment.

Computational tools capable of general intelligence, also referred to as artificial intelligence (AI), can be used to perform a vast variety of functions in several domains like communication, engineering, research, security and protection, agriculture, livestock management, and so on. Tools of artificial intelligence are increasingly used in several domains for performing several tasks with increasing complexity. One example implementation of artificial intelligence is via learning agents, which are digital agents capable of general intelligence and can operate in an environment and implement or cause the implementation of one or more functions to accomplish one or more identified tasks in that environment. Digital agents can be learning agents that start with a basic knowledge of an environment capable of learning from their experience

Learning agents (e.g., reinforcement learning (RL) agents) are typically trained in environments where the dynamics of the environment are statistically consistent or stationary over time. Stationary variables in an environment can lead to systems and agents learning strategies to update hyperparameter values that are static and/or use simple heuristic approaches for adjusting hyperparameter values. Such systems trained using statistically stationary environments, however, do not adapt well to the non-stationary environments in real world applications. Therefore, deploying systems trained in stationary environments can lead to agent underperformance in non-stationary environments in real world applications, as previous models of the world may no longer be the same and the learned strategies may no longer be applicable. It is computationally not simple to generate alternative strategies for every possible configuration of environments with which agents may possibly interact.

Disclosed embodiments describe systems and methods that address the problem of non-stationarity in environments by implementing agents who's behavior and learning can be automatically adjusted based on the environmental non-stationarities by automatic adjustment of hyperparameters associated with a learning algorithm used to reinforce and/or train the agents. Hyperparameters can include lambda indicating a learning rate, gamma indicating a measure of discount of future rewards, and/or epsilon indicating a coefficient of greediness in the agent's interactions with the environment. Coefficient of greediness can be indicative of a balance between an explorative behavior of an agent and an exploitative behavior of an agent, as described herein. Disclosed embodiments describe systems and methods that implement learning agents, for example RL agents, that track the evolution of an agent's performance over time and adjust the hyperparameters used in the associated learning models by the agent to improve the risk-adjusted returns over time. As described in embodiments disclosed herein, the agents improve returns through the use of world context and the Sharpe Ratio for reward signals based on the external rewards received by the agent.

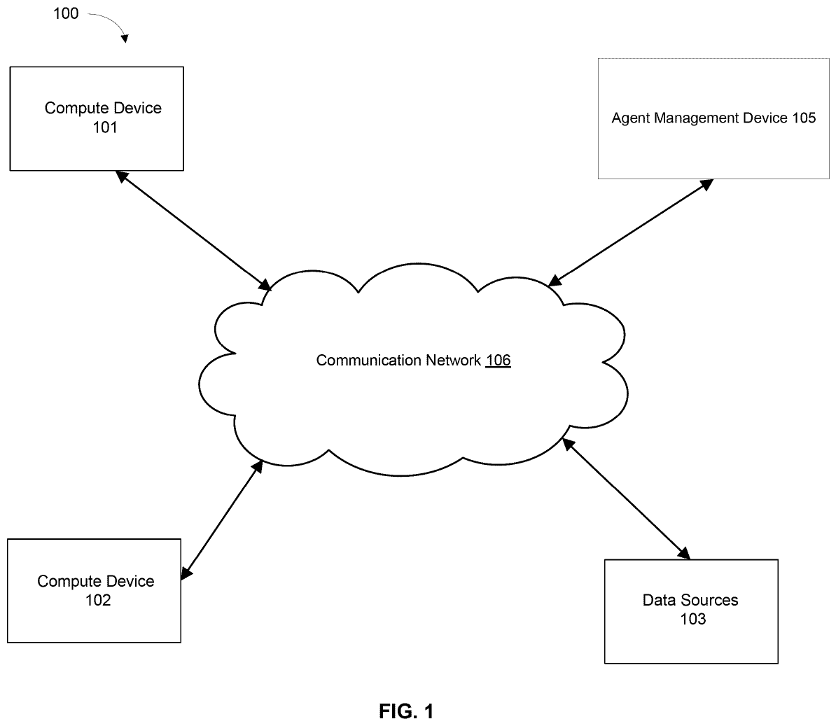

FIG. 1 is a schematic illustration of an agent management system 100, also referred to herein as “an AM system” or “a system”. The AM system 100 is configured to aggregate data associated with one or more environments and generate agents (e.g., digital learning agents) configured to navigate the one or more environments, using machine learning models and/or tools, based on the aggregated data. The AM system 100 can be configured to provide data to the agents as basic knowledge and incremental knowledge associated with the one or more environments, to provide tasks for the agents to accomplish in the environment, to aid the agents to learn to better navigate or better perform within the environment, to assess the performance of the agents, and/or to adjust one or more parameters associated with the learning of the agents to improve agent behavior, improve agent performance, and/or to achieve desired results.

The AM system 100 can be used to implement agents in any suitable environment where one or more functions are to be carried out using autonomous operation to achieve identified tasks. Some example implementations can include applications in trading and finance, autonomous driving of automobiles, robotics, automation of equipment in industries, natural language processing including machine translation, speech recognition, speech generation, conversation generation, customer-oriented service applications in entertainment, media, gaming, advertisement, applications in healthcare including diagnosis, treatment management, and/or the like. The AM system 100 can be used to implement machine learning models to generate agents and adaptively improve behavior of agents in such applications in their respective environments, to adaptively improve performance of the agents to achieve identified results, for example, improved performance in finance and trading, improved navigation in autonomous driving, improved manipulations in robotics, improved diagnosis and/or treatment management in healthcare, and/or the like. The AM system 100 can be configured to generate and manage agents and induce the agents to learn via any suitable learning algorithm and/or model (e.g., supervised, semi-supervised, or unsupervised learning). In some implementations, the agents can be configured to learn via reinforcement learning.

In each environment a desired task can be performed by an agent via a series of actions that result in a series of state changes, following an autonomously generated procedure, as described in further detail below. Certain actions can be associated with certain rewards. The agent can be configured to learn to improve behavior based on outcomes of each action to make better decisions in subsequent actions. Each step performed by the agent can be based on a policy that is defined by one or more parameters. The learning of an agent can be according to a learning algorithm and based on a policy that is defined based on one or more hyperparameters. In some implementations, the hyperparameters defining the learning of the agent can be based on the policy. The agent can select a policy from a plurality of policies. Each policy can vary from the other policies by one or more parameters that dictate agent behavior and/or by hyperparameters that define learning of the agent. The AM system 100 can be configured such that the agent can suitably adapt not only its behavior at making action choices but also its learning based on changes perceived in the environment. Similarly stated, the AM system 100 can be configured to gather data associated with the environment and based on the data perceive one or more changes associated with the environment and configure the agent to automatically modify one or more hyperparameters associated with learning of the agent (e.g., lambda indicating a learning rate, gamma indicating a measure of discount of future rewards, or epsilon indicating a coefficient of greediness in the agent's interactions with the environment) such that the agent can learn strategies to adopt a better policy of behavior to better navigate the environment under the changes circumstances.

In some embodiments, the AM system 100 can be used to improve procedures adaptively to meet desired goals, defined based on improvement or maintenance in one or more target features in the environment, even when traversing non-stationary fluctuations in the environment. In some implementations, training of a Reinforcement Learning (RL) agent can involve performing many trials within an environment so that the agent learns how to perform actions in an improved and/or intelligent manner. As part of the training, numerous agent hyperparameters such as learning rate, future reward discount, epsilon indicating a greedy threshold and more can be adjusted so that when the agent is trained the agent can focus on reward improvement and/or maximization with respect to that environment. When agents are implemented in real world environments, however, there can be some challenges in improving agent behavior. The approach of adjusting agent behavior can fail to respond to dynamics needs of the environment, which are often prevalent in real world environments. The systems and methods disclosed herein include implementing algorithms and/or models using a machine learning (ML) model based on reinforcement learning (RL) to automatically update the hyperparameters of an agent as the environment changes. In some implementations, the disclosed systems and methods leverage the Sharpe Ratio as the reward signal to adjust hyperparameter values as the agent interacts with the environment.

The AM system 100 is configured to generate and implement agents using machine learning models and/or tools to accomplish identified tasks. The AM system 100 can be implemented, for example, in a financial environment and used to generate and manage agents configured to carry out analysis of market conditions, analyze market value and/or predicted trends in value of securities, such as stocks, bonds, currencies, commodities, services, and/or the like, track financial markets in financial environments, generate context associated with financial markets at various time periods, make decisions to buy and/or sell one or more securities, perform actions to buy and/or sell one or more securities, gather data associated with the actions performed, gather data to measure performance of agents conducting trades over various time points, manage a trading portfolio, determine changes or non-stationary fluctuations in a market (e.g., a market depression), adjust agent behavior and/or learning of the agents conducting trades via adjusting hyperparameters, compare current context to known contexts, apply policies, temporal abstractions, and/or parameters chosen based on prior known contexts and associated outcomes, and so on.

The AM system 100 is configured to generate and deploy agents that operate in an environment. The agents operate in the environment by performing actions that lead to states of the environment. Actions and states in the environment can be associated with reinforcing signals-either positive reinforcements or reward signals that are positive or negative reinforcement or reward signals that are negative. The AM system 100 is configured to receive information from the environment in which one or more agents are deployed to accomplish one or more tasks. The information can be data associated with state of the one or more agents in the environment, states of the environment, changes in states based on agent actions, changes in the environment, reward signals, additional information that is relevant to the environment, the agent, and/or its task/goals, contextual information associated with history of the environment, behavior of the agent, and consequences to agent actions, and/or the like. The AM system 100 is configured to automatically adjust one or more parameters associated with agent behavior and/or automatically adjust one or more hyperparameters associated with a learning algorithm directing learning of the agent, based on the information received from the environment, according to an embodiment.

The AM system 100 includes compute devices 101, 102, data sources 103, agent management device 105 (also referred to as “the device”) connected to each other through a communications network 106, as illustrated in FIG. 1. In some embodiments, the compute devices can be client or user devices (e.g., mobile phones, computers, laptops, tablets or other client devices). Such compute devices 101, 102 can, for example, provide information and/or feedback associated with an environment to the data sources 103 and/or the agent management device 105. For example, in some circumstances, when the system 100 can be used to generate and implement agents in a financial trading environment, the compute devices 101, 102, can include compute devices associated with traders and/or investors. The data sources 103 can receive and store data from the compute devices 101, 102 and can include a data source associated with the trading platform that provides information associated with the trading environment to the agent management device 105. As another example, in a livestock management environment, the compute devices 101, 102 can be user devices associated with farmers, animals handlers, customers of the bioproduct yielded by the farmers, facilities providing health care/fodder for livestock, and/or the like. The data sources 103 can be associated with a market for the bioproduct, and/or the like. As another example, in an automated manipulation of instrumentation environment, the compute devices 102, 103 can be user devices associated with other equipment, users, manufacturers, vendors, and/or the like providing additional information related to the environment. As another example, in a speech generation environment, the compute devices 101, 102 can be user devices associated with users invoking the system 100 to perform speech generation and/or translation. The data sources 103 can be a database associated with speech generation data, context, etc. providing additional information related to the environment. While the AM system 100 is illustrated to include two compute devices 101-102, and one data source 103, a similar AM system can include any number of compute devices and/or any number of data sources.

In some embodiments, the communication network 106 (also referred to as “the network”) can be any suitable communications network for transferring data, operating over public and/or private networks. For example, the network 106 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the communication network 106 can be a wireless network such as, for example, a Wi-Fi or wireless local area network (“WLAN”), a wireless wide area network (“WWAN”), and/or a cellular network. In other instances, the communication network 106 can be a wired network such as, for example, an Ethernet network, a digital subscription line (“DSL”) network, a broadband network, and/or a fiber-optic network. In some instances, the network can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS)). The communications sent via the network 106 can be encrypted or unencrypted. In some instances, the communication network 106 can include multiple networks or subnetworks operatively coupled to one another by, for example, network bridges, routers, switches, gateways and/or the like (not shown).

The compute devices 101 and 102 in the AM system 100 can each be any suitable hardware-based computing device and/or a multimedia device, such as, for example, a device, a desktop compute device, a smartphone, a tablet, a wearable device, a laptop and/or the like. The data source 103 can be any suitable data source, for example, a database of information, a server or similar device handling information associated with an environment, an external network of devices, and/or the like. In some embodiments, the agent management device 105 can generate and implement learning agent, for example, reinforcement learning agents, gather information as the RL agents navigate the environment, create and/or define policies for operation of the agents, and suitably adjust hyperparameters to increase likelihood that the agents accomplish identified tasks.

Reinforcement Learning (RL) can be used to create, define and/or implement agents. RL is an area of machine learning that is related to the study and implementation of how intelligent agents ought to take actions in an environment in order to maximize and/or improve a predefined concept of cumulative reward. RL can be used to implement intelligent digital agents.

In some implementations, RL described herein offers some advantages in the form of not requiring labeled data for training and not needing sub-optimal actions to be explicitly identified and/or corrected. In some implementations, RL described herein can have a goal of finding a balance between exploration (of unknown areas in an environment that may potentially have higher or lower rewards) and exploitation (of current knowledge of the environment). In some embodiments, RL described herein can be implemented as partially supervised RL that combines the advantages of supervised and unsupervised RL algorithms.

RL, as described herein, can be inspired by how humans and animals learn from interacting with an environment. In some embodiments, RL can operate by assuming that the agent is actively pursuing a fixed set of goals. As described herein and in some implementations, through exploring its action space, the agent can gradually learn the best and/or an improved strategy to maximize and/or improve the agent's utilities. RL, as described herein, for example, can be described as a Markov Decision Process (MDP), with a tuple [symbol] S, A, Pa, R [symbol] , where S is the set of states the agent can possess, A is the set of actions the agent can take, Pa is the probability of state transitions by performing action ‘a’ at state ‘s’, defined as Pa=P[sₜ₊₁=s′−sₜ=s, aₜ=a], and R is the reward received from the environment. Similar to how biological organisms interact with the world, the digital agents generated using systems implementing RL as described herein, can learn how to create policies by optimizing and/or improving a reward signal produced by the environment, which can be suitably represented via the system. Through interacting with the environment over time (t), the agent can learn a policy x, that maximizes and/or improves the agent's future reward.

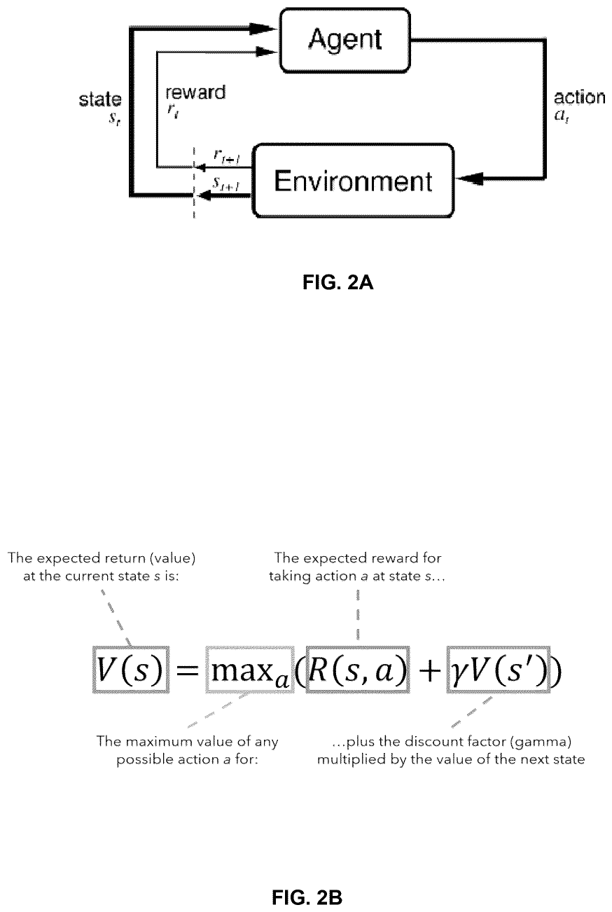

FIG. 2A is a schematic representation of an example system implementing an agent using RL, according to an embodiment. The system can be based on any suitable agent architecture that determines interactions between the agent and the environment, as described herein.

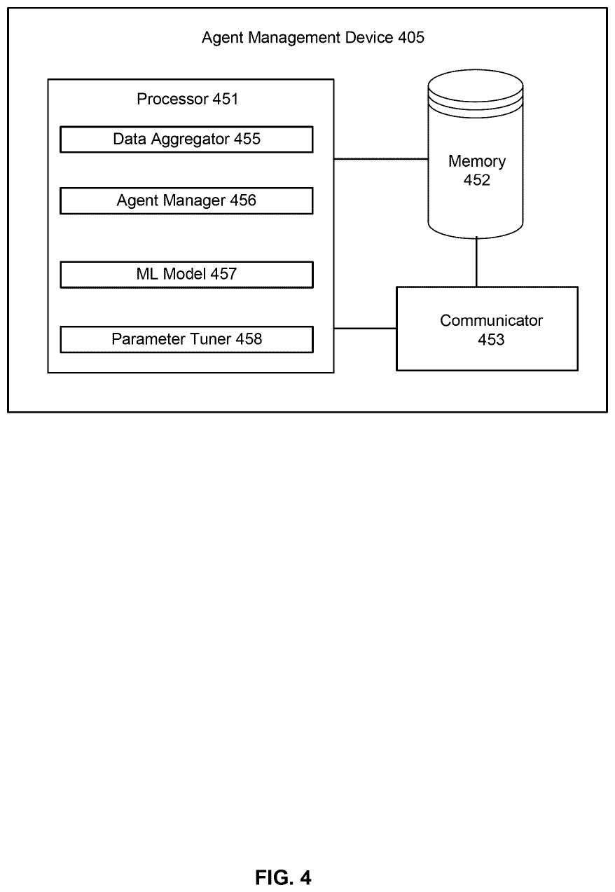

In some implementations, a system can use one or more machine learning models (not shown in FIG. 2A) that can be executed by an agent management (not shown in FIG. 2A). The compute device can be any suitable processing device (e.g., compute devices 101, 102 of system 100 in FIG. 1) and the agent management device can be any suitable processing device (e.g., agent management device 105 of system 100 in FIG. 1, agent management device 405 in FIG. 4). The system 200 can generate an agent and using RL, can configure the agent to take actions (at) in an environment. The system can use any suitable agent architecture to generate the agent and to determine agent behavior. The agent architecture can include one or more machine learning models.

In some implementations, the one or more machine learning models can be configured to receive suitable input (e.g., goals, rewards, policies, input from or representative of variables in the environment, internal inputs from the system, etc.) and generate outputs that can be used to determine agent behavior (e.g., agent's action) in the environment. The agent's action in the environment is then interpreted by the system into a reward (rₜ) and a representation of the state (sₜ), which are provided to the agent. Following which, the agent can evaluate the inputs and determine another action (aₜ₊₁) in the environment. The agent's action (aₜ₊₁) then results in a reward (rₜ₊₁) and a representation of the state (sₜ₊₁) and so on. Based on the actions taken and/or performed, states reached, rewards received, and/or the like, the system can use any suitable optimization and/or improvement procedure to learn to improve behavior and take optimal and/or improved actions towards a desired goal. In some implementations, the optimization and/or improvement can be directed such that a cumulative reward is optimized and/or improved and/or the agent gets closer towards a predefined goal.

In some implementations, as described herein, through the use of the Bellman Optimization algorithm, agents can learn how to improve their behavior to improve their future reward. FIG. 2B is an equation forming the basis of the optimization and/or improvement, according to some implementations of the systems and methods disclosed herein.

In some implementations, the systems described herein can use one or more of several RL models and/or algorithms to implement the agent. In some implementations, for example, a Q-learning model and/or algorithm can be used. The Q-learning model is a value-based model-free reinforcement learning model. The Q-learning model can be configured to estimate the Q value represented by (state, action) pairs of values. Each Q-value can be associated with a state (s) and an action (a) forming pairs of (state, action) values. Q-Learning can estimate the Q-value using a temporal difference update, for example: Q(sₜ, aₜ)=rₜ+maxa′Q(s′,a′).

Deep learning can be used with RL models and/or algorithms. In some implementations, Q-learning implemented using deep network models (also referred to as Deep Q-Networks, DQN) can replace a Q-table with a neural network and can further improve the effectiveness of learning using experience replay. In some implementations, double DQN and dueling DQN can use separate neural networks to stabilize the weights of a neural network during training. In some implementations, a deep deterministic policy gradient (DDPG) model can extend Q learning to a continuous action space. In some implementations, a trust region policy optimization (TRPO) model and/or algorithm can improve the efficiency of Q learning by limiting the direction of the gradient descent process. In some implementations, a Proximal Policy Optimization (PPO) algorithm and/or model can further optimize and/or improve a TRPO model by providing an approximation function that runs faster than TRPG the majority of the time. In some implementations, a Hierarchical Reinforcement Learning (HRL) model and/or algorithm, as disclosed herein, solves long-horizon problems with little or sparse rewards. HRL can improve upon Q learning by enabling the agent to plan behaviors more efficiently while still learning low-level policies for execution. In one implementation, the agent architecture includes modules at a first level, for example, a high level within a hierarchy of models, that learn policies of high-level options execution, while a module at a second level, for example, a bottom-level within the hierarchy of models, learns policies to execute various options.

In some implementations, agent behavior in an environment and its learning based on interactions with the environment can be set by a plurality of values. Each value can be associated with a hyperparameter from a plurality of hyperparameters. Selection of hyperparameters can be based on the learning algorithms implemented by the ML models used to train agents to improve performance in a given environment. Some example hyperparameters used with some example learning algorithms include lambda indicating a learning rate, gamma indicating a measure of discount of future rewards, or epsilon indicating a coefficient of greediness in the agent's interactions with the environment, which can be used in implementing an epsilon greedy strategy or an algorithm for agent learning using, for example, Deep Q learning.

As an example, lambda (λ) can denote a learning rate associated with learning of an agent. For example, lambda (λ) can be a value between zero and one (0≤λ≤1). If λ is set to zero, the agent learns nothing from new actions and consequences from the new actions. If λ is set to 1, the agent completely ignores prior knowledge from past experiences in the same environment and only values the most recent information from new actions and their consequences. Higher λ values can make Q-values change faster. However, higher λ values can also lead to high variability in values and rewards.

As another example, gamma (γ) can denote a discount factor associated with future rewards (or delayed rewards) that can impact the learning of an agent. When multiplied with future rewards, gamma can change the value of future rewards. For example, gamma (γ) can take a value between zero and one (0≤γ≤1). If γ is set to zero, the agent is configured to not value future rewards at all or completely ignore future rewards when making decisions on action selection. If γ is set to 1, however, the agent is configured to seek high value rewards in the future, and make action selection to increase likelihood of high rewards on a longer time period. Higher γ values can make an agent chose actions that can be detrimental in the short term or can deter agents from reaping rewards in the short term.

As another example, epsilon (ε) can denote a coefficient of greediness associated with an agent's action selection strategy when interacting in an environment. In some implementations, an agent can employ a strategy that involves balancing exploratory behavior with exploitative behavior, via action selection, such that the goal of improving and/or maximizing rewards is achieved. Exploratory behavior can include actions associated with the agent learning new features about the environment. For example, an agent randomly selecting an action from a set of available actions at a given state can be an exploratory behavior, which can result in the agent learning the consequences associated with each action from the set of actions. Exploratory behavior can be associated with a higher risk, as an action may lead to low rewards or negative rewards (e.g., bad consequences) depending on the environment. Exploratory behavior can also provide the agent more information about the environment which can be used to make better future decisions. Exploitative behavior can include selecting the action with the highest expectation of reward given the currently available information. An agent can compute expected rewards associated with each available action from a set of actions The value of epsilon (ε) can take a value between zero and one (0≤ε≤1). If ε is set to zero, the agent is configured to not explore the environment through potentially risky actions that may lead to unknown rewards (including potential high rewards). The agent instead is exploitative in behavior, that is, the agent takes the safe action choice that has the maximum expectation of reward (even if it is a small reward expectation) at that current state. If ε is set to 1, however, the agent is configured to take riskier action choices, including randomly selected action choices that may lead to unknown high value rewards or may lead to high negative consequences. Higher ε values can help an agent have safe returns, but runs the risk that an agent gets stuck in a smaller reward strategy and not fully taking advantage of an environment that includes better rewards to get collected. Lower ε values can help an agent better understand the dynamics of an environment and not get stuck in a local maxima of rewards, but runs the risk of unexpected low rewards or even negative rewards or losses.

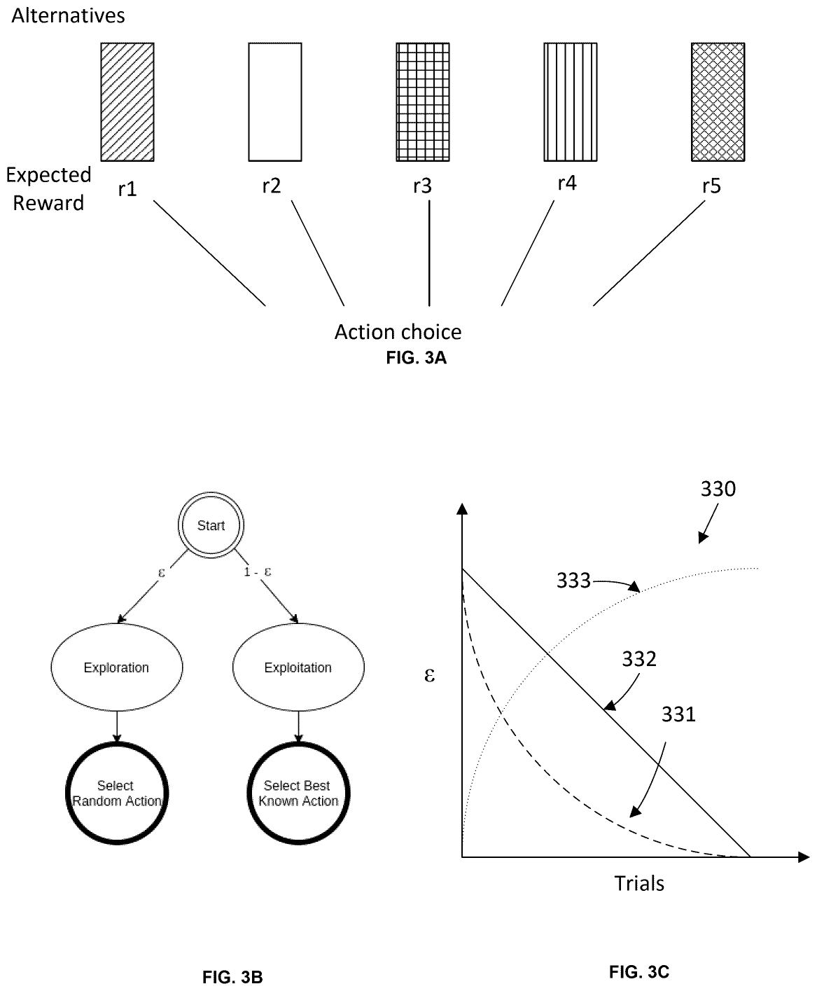

FIG. 3A illustrates an example of an environment in which an agent can be implemented by the AM systems described herein, according to an embodiment, wherein the agent is configured to perform actions to maximize rewards. As an example, the environment can include five slot machines, each with a different reward or return rate, for example, probability of a reward, r1, r2, r3, r4, and r5. The AM system disclosed herein (e.g., system 100, 900 and/or systems used with reference to details described in FIGS. 2A, 2B, 3A, 3B, and/or 4, etc.), can implement the agent to navigate the environment and perform actions like playing the slot machines, to accomplish goals, for example a goal of maximizing and/or improving cumulative returns from the slot machines, via an AM device (e.g., AM device 105, 405). The agent can get multiple rounds, trials, or attempts to play one of the five slot machines, and each round involves the agent making an action (selecting a slot machine to play and playing the selected slot machine), which results in a state that is associated with a reward.

The agent can use any suitable strategy to evaluate available actions, select an action at each state, and collect rewards. In some implementations, the AM system can use an epsilon greedy strategy to balance between exploratory behavior (of taking risks and discovering the difference between the slot machines, and their respective return rates, which are initially unknown to the agent) and exploitative behavior (of repeatedly choosing a “safe slot machine” that may have a return rate “r” which may or may not be an optimal choice to maximize returns as there may be an unselected slot machine that has a much higher return rate that the agent has not explored).

FIG. 3B illustrates an implementation of an epsilon-greedy strategy to navigate the environment of FIG. 3A, by an agent implemented by an AM system, according to an embodiment.

According to the epsilon-greedy strategy, at the start of each trial or round the agent is faced with two alternative action strategies to make the next action selection, which machine to play in that round. The strategies vary in their degree of risk and the balance of exploratory-exploitative behavior, and the strategy is selected based on the coefficient of greediness, epsilon, set in a policy π adopted by the agent for that trial. The illustration in FIG. 3B shows the choices available to the agent in an example round or trial, according to an embodiment. The agent follows a policy π that includes an epsilon value ε denoting coefficient of greediness. The value of ε is set prior to the beginning of the trial and determines the degree to which the agent may act in an explorative or an exploitative nature. As shown in FIG. 3B, the trial begins at start and the agent selects a machine from the five machines available to play. The agent generates a random number ‘p’ from 0.0 to 1.0. If the random number p is greater than the value of ε, the agent will select the best-known action, that is the agent will select the best machine with the highest expected payout as determined with currently available data associated with the environment (i.e., the machine with the highest rx value), in an exploitative manner. Initially the agent has no knowledge of the values of r1, r2, r3, r4, and r5, and has to play each machine to discover these values. According to this policy π, the exploitative choice will be made with a probability of (1-8), as indicated by the illustration in FIG. 3B. If the p value is lesser than ε, the agent selects a random action from those available, that is the agent randomly selects a machine to play, in an exploratory manner. According to this policy π, the exploratory choice will be made with a probability of ε. The exploratory choices can allow the agent discover the values of r1, r2, r3, r4, and r5, with a greater confidence as the agent plays each machine with increasing repetition. But these exploratory choices can prevent the agent from taking advantage of a safe knowledge of some expected reward in one of the machines.

For example, the value ε in a policy π can be 0.9. In this example, in a given round, an agent will generate a random number p that will be greater than 0.9 in 10% of trials and will be lesser than 0.9 in 90% of trials. Therefore, the agent will engage in an exploitative behavior (and select the safe choice) in 10% of the trials and the agent will engage in exploratory behavior (by selecting the riskier choice that may be more informative of the values of r1, r2, r3, r4, and r5 in the environment) in 90% of the trials.

Initially, when an agent is first introduced or deployed in an environment, the agent may desirably act in a more exploratory manner (i.e., with a greater value of) as the agent may be uninformed of the values of r1, r2, r3, r4, and r5 in the environment. With increased knowledge of the environment, however, the agent may desirably switch to an increasingly exploitative behavior to achieve its goal of maximizing and/or improving rewards. That is, with increased experience in a particular environment, the agent may benefit from switching to decreasing values of the hyperparameter ε to achieve the agent's goal of maximizing and/or improving rewards. Additionally, in non-stationary environments, where the environmental features change with time (e.g., values of r1, r2, r3, r4, and r5 are not static but they change with time), the agent may desirably be able to switch from increasingly exploitative to increasingly explorative behaviors, and vice versa, as the agent senses changes in the environment.

The embodiments disclosed herein describe systems and methods that can used, via an AM system, to automatically update the value of the hyperparameter ε in the policy π to a new value ε′ in a policy π′ such that the agent can update its behavior to increase its likelihood of achieving the goal of maximizing and/or improving rewards. FIG. 3C shows a plot 330 showing three example curves 331, 332, and 333 representing three example methods of how policies can be updated, for example, based on an environment, such that the value of ε is changed with increasing number of trials to meet changes in the environment. For example, according to the curve 331, the value of ε can be reduced exponentially, with increasing number of trials. Whereas according to the curve 332, the value of ε can be decreased linearly, with increasing number of trials. As another example, according to the curve 333, the value of ε can be increased with increasing number of trials.

RL agents can be trained in environments where the dynamics of the world are consistent or stationary from a statistical perspective. Such a training leads to hyperparameter value update strategies that are static or use simple heuristic approaches to adjust. Such update strategies can lead to agent underperformance as previous models of the world may no longer be the same, and/or the agent strategies may not be changed in time to take advantage of the changed environments. Embodiments disclosed adopt systems and methods that update policies and strategies of agent interaction automatically, thereby meeting changes in a non-stationary environment with changes in agent behavior to best perform in the changes environment to maximize and/or improve rewards.

FIG. 4 is a schematic representation of an AM device 405 that is part of an AM system, which can be substantially similar to the AM system 100 described in FIG. 1. The AM device 405 can be structurally and/or functionally similar to the AM device 105 of the system 100 illustrated in FIG. 1. The AM device 405 can be a compute device (similar to the agent management device 105 of system 100 in FIG. 1) configured to implement an agent tasked to navigate an environment, using one or more ML models and/or algorithms or methods described herein, according to an embodiment. The AM device 405 includes a communicator 453, a memory 452, and a processor 451.

The communicator 453 of the AM device 405 can be a hardware device operatively coupled to the processor 451 and the memory 452 and/or software stored in the device memory 452 executed by the processor 451. The communicator 453 can be, for example, a network interface card (NIC), a Wi-Fi™ module, a Bluetooth® module and/or any other suitable wired and/or wireless communication device. Furthermore, the communicator 453 can include a switch, a router, a hub and/or any other network device. The communicator 453 can be configured to connect the AM device 405 to a communication network (such as the communication network 106 shown in FIG. 1). In some instances, the communicator 453 can be configured to connect to a communication network such as, for example, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

The memory 452 of the AM device 405 can be a random-access memory (RAM), a memory buffer, a hard drive, a read-only memory (ROM), an erasable programmable read-only memory (EPROM), and/or the like. The memory 452 can store, for example, one or more software modules and/or code that can include instructions to cause the processor 451 to perform one or more processes, functions, and/or the like. In some implementations, the memory 452 can be a portable memory (e.g., a flash drive, a portable hard disk, and/or the like) that can be operatively coupled to the processor 451. In some instances, the memory can be remotely operatively coupled with the AM device. For example, the memory can be a remote database device operatively coupled to the AM device.

The processor 451 can be a hardware based integrated circuit (IC) or any other suitable processing device configured to run and/or execute a set of instructions or code. For example, the processor 451 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 451 is operatively coupled to the memory 452 through a system bus (e.g., address bus, data bus and/or control bus). The processor 451 is operatively coupled with the communicator 453 through a suitable connection or device.

The processor 452 can be configured to include and/or execute several components, units and/or instructions that may be configured to perform several functions, as described in further detail herein. The components can be hardware-based components (e.g., an integrated circuit (IC) or any other suitable processing device configured to run and/or execute a set of instructions or code) or software-based components (executed by the processor 452), or a combination of the two. As illustrated in FIG. 4, the processor 451 includes a data aggregator 455, an agent manager 456, an ML model 457, and a parameter tuner 458.

The data aggregator 455 executed by the processor 451 can be configured to receive communications between the device 405 and compute devices connected to the device 405 through suitable communication networks (e.g., compute devices 101-102 connected to the device 105 via the communication network 106 in the system 100 in FIG. 1). The data aggregator 455 is configured to receive from the compute devices and data sources (now shown in FIG. 4) included in the AM system, information collected, stored, and/or generated by the compute devices and data sources. The compute devices and/or data sources can be related to the environment in which the AM system has implemented agents to navigate and operate via the AM device 405. As an example, the environment can be in animal handling and maintenance of livestock for producing a desired bioproduct (e.g., milk, eggs, honey, dairy products like cheese, yogurt, etc.). The agents can be implemented to navigate the environment of managing livestock and making decision related to health case, feeding, treatment, breeding and/or the like to generate desired product to meet a target demand. As an example, the data from the various compute devices and/or data sources can, in some instances, include one or more logs or records or other data relating to animal handling of a managed livestock, feed schedule associated with individual animals, health status, bioproduct producing status, reproductive status, and/or progeny associated with individual animals, recommendations of feed, medicinal treatment and/or dietary supplement for individual animals, schedules of medicinal treatments and/or dietary supplements provided to individual animals, productions of bioproducts by individual animals, history of bioproduct producing status or phases in production cycle, history of production of bioproducts including measures of a quantity and/or quality of bioproducts, an indication of properties of a bioproduct that may be of interest (e.g., a measure of protein content of milk that is of interest to customers who are manufacturers of milk products), history of reproductive status, number of pregnancies/live births associated with a reproductive history of an animal, a measure of costs associated with maintenance of livestock, and/or the like. In some instances, the bioproducts can be intended for various end uses based on trends and/or market context that can aid in deciding a target production rate and/or number/type of clients to be served or a number of producing animals to be maintained in a cohort of livestock. For example, animals producing milk can be raised to maintain a target production quality and rate or target health to ensure production of a target quantity and/or quality of milk to meet a variety of end uses that includes, for example, drinking milk, milk used to produce cheese, milk used to produce butter, milk used to produce yogurt, milk used to produce ice cream, milk used in baking, etc.

As another example, the environment can be financial trading and the AM device 405 can implement agents to navigate a trading environment by trading stocks and bonds, comparing stocks, measuring indicators such as, for example, liquidity, volatility, volume, momentum in a market trend, etc., associated with trading, determining indicia to obtain information on market trends and context associated with a market, selecting companies whose stocks to follow and trade on, selecting commodities that may indicate trading decisions, generating criteria to make trading decisions upon, making trading decisions to increase long term/short term rewards, and/or liquidity, and/or the like. As another example, the environment can be a physically navigable environment and the AM device 405 can implement agents to navigate an autonomously navigated vehicle, or the environment can be automation of an equipment or instrumentation in a real-world environment and the AM device 405 can implement agents to physically manipulate one or more parts of the instrumentation or equipment to accomplish a task. Additional examples can include any suitable environment including real and virtual environments where an autonomous entity is used to make decisions based on available alternatives to generate outcomes (e.g., where one or more particular directions of outcomes can be identified as desired or preferred), translating and/or generating speech or written product, transacting with other entities (real or virtual), generating or modifying strategies (e.g., in a single or multiplayer scenario in a real world or a virtual world), navigating an autonomously navigated vehicle, and the like.

The data aggregator 455 is configured to receive data associated with history of the environment, history of interactions of the agent with the environment, history of actions, state changes, and rewards, history of external events that have had an impact on the environment, and/or the like. In some instances, the data aggregator 455 can be configured to receive a record of information related to a sequence of events (e.g., a schedule of interventions such as, for example, changes in feed blend, medicinal treatments, or dietary supplements provided to individual animals, schedule of trading positions, a schedule of automated navigation or manipulations, etc., as the case of the respective environment may be) and/or a concurrent set of data logged indicating one or more states of the environment (e.g., health status, a property associated with a health status, and/or a production of bioproducts by managed livestock, concurrent market details, major events in the real world that may impact the environment in questions, etc.). In some implementations, the data aggregator 455 can receive the information sent by the compute devices at one or more specified time points or intervals. In some implementations, the data aggregator 455 can be configured to query the compute devices at one or more specified time points or time intervals to receive the data or information in response to the query. In some implementations, the data aggregator 455 can be configured to send queries and/or receive data/information from compute devices and/or data sources automatically and/or in response to an agent generated action and/or a user generated action (e.g., user activated transmission of a query via a software user interface). In some instances, the data aggregator 455 can be further configured to receive, data associated with day-to-day and/or regularly scheduled information associated with the environment and information associated with unscheduled or unexpected events including statistically anomalous data etc.

In some instances, the data aggregator 455 can be further configured to receive, analyze, and/or store communications to and/or from compute devices and/or data sources regarding any suitable information related to the environment. The data aggregator 455 can receive, analyze, and/or store information associated with one or more target states or target tasks to be accomplished by the one or more agents managed by the AM device 405. The information received from a compute device can include, for example, one or more threshold values related to a target property associated with the environment (e.g., a health status of a livestock, a quantity/quality associated with health status of animals, a quantity/quality associated with a bioproduct produced by animals such as milk, eggs, honey, fiber, etc., a target profit or trend in profit in a trading portfolio, a target successful completion of autonomous navigation of a vehicle or autonomous manipulation of instrumentation, a target completion of a task or an outcome related to strategic decision making or speech generation, etc. and/or the like).

In some embodiments, the data aggregator 455 can be configured to monitor and store information associated with interactions of the one or more agents with the one or more environments over a desired period of time. For example, the data aggregator 455 can monitor and store the policy used, features of the environment, the rewards received, the actions selected by the agents at the states associated with the agents for each actions, and/or other data that may be relevant or informative of the conditions of the environment, the behavior of the agent, and the resulting consequences.

The data aggregator 455 can be configured to determine one or more measures of performance associated with interactions of the one or more agents deployed in an environment with the environment. The measures of performance can be determined using any suitable metric. In some embodiments, the data aggregator 455 can track agent performance, determine measures of the agent's performance, and provide the measures of agent performance to the agent manager 456, the ML model 457, and/or the parameter tuner 458, for providing a feedback signal on agent behavior, for providing additional input to the ML model 457, and/or to provide one or more indicia based on which one or more of agent policies, parameters, or hyperparameters associated with learning of the agent can be adjusted or tuned automatically or based on user preference/user initiation. An agent can be implemented to interact with an environment based on a policy (e.g., a strategy selected from a plurality of strategies to make decisions on what actions to choose at each state of the environment that the agent resides) wherein the policy determines the actions that an agent can perform for every possible state in that environment. For example, the data aggregator 455 can be configured to calculate a first measure of performance. The first measure of performance of an agent can be any suitable metric indicative of interactions of that agent with that environment. For example, the first measure of performance can be a value associated with rewards or reward signals received by the agent based on actions performed by the agent at specific states (state, action). In some implementations, the first measure of performance can be an expected value associated with rewards or reward signals received from the environment in response to agent actions when following a first policy. In some implementations, the first measure of performance can be a mean value associated with rewards or rewards signals. For example, the first measure of performance can be a sum of rewards received within a time window, when the agent operated under a first policy, divided by the count of rewards received within the time window. In some implementations, the first measure of performance can be a median, mode, average, or any other suitable measure of central tendency associated with the rewards or rewards signals received following agent actions over an identified first period of time, and/or when the agent was engaged with an environment using a first policy set by the agent manager 456, the agent behavior and/or the agent learning being based on the first policy. The data aggregator 455 can be configured to calculate a second measure of performance associated with the interactions of the agent with the environment over an identified second period of time. The second measure of performance can be based on interactions when the agent was engaging with the environment using a second policy different than the first policy (and/or at a different time period, under different context, and/or the like). For example, the second measure of performance can be a sum of rewards received within a time window, when the agent operated under a second policy, divided by the count of rewards received within the time window. The difference between the first policy and the second policy can be based on the value associated with one or more parameters and/or hyperparameters. In some implementations, the second policy can be a policy defined using an epsilon ε that is below a predefined threshold. The data aggregator 455 can calculate one or more measures of comparison between the first measure of performance and the second measure of performance such that the agent's performance using two different policies can be compared and evaluated.

The data aggregator 455 can use any suitable method to compare and/or evaluate the first policy and the second policy. In some implementations, the data aggregator 455 can use the Sharpe ratio to compare and/or evaluate two measures of performance. In finance, the Sharpe ratio can be used to compare the performance of investment portfolios. In some implementations, the data aggregator 455 can use the Sharpe ratio to compare performance of an agent under two paradigms based on which the two measures of performance are calculated. In some implementations, the data aggregator 455 can be configured to calculate a first measure of performance that is an expected value of rewards associated with the agent's interactions with the environment according to the first policy, and a second measure of performance that is an expected value of rewards associated with the agent's interactions with the environment according to the second policy. The second policy can be selected such that the second policy is associated with greedy interactions of the agent with the environment. Said in another way, the second policy can include a value ε for the hyperparameter epsilon that is below a predefined threshold value.

In some implementations, for the Sharpe ratio, the data aggregator 455 can calculate a difference between the first measure of performance and the second measure of performance. The data aggregator 455 can compute a measure of variance associated with the first measure of performance associated with the interactions of the agent with the environment. The data aggregator 455 can then compute a Sharpe ratio based on the difference between the first measure of performance and the second measure of performance and the measure of variance associated with the first measure of performance associated with the interactions of the agent with the environment. For example, the data aggregator 455 can compute a standard deviation associated with the rewards associated with the agent's interactions with the environment according to the first policy, and then compute a Sharpe ratio of the difference the first measure of performance and the second measure of performance and the standard deviation associated with the rewards associated with the agent's interactions with the environment according to the first policy. The data aggregator 455 can then provide the Sharpe ratio to the parameter tuner 458 such that the Sharpe ratio can be used to automatically modify the policy to a new policy by automatically changing at least one current value of a hyperparameter used by the ML model 457 to manage agent behavior based on the Sharpe ratio, as described herein. The data aggregator 455 can compute the Sharpe ratio for an identified first policy and second policy over a sliding window of recent history. In some implementations, the average of this value can be used as a risk-free rate of the agent, as described herein.

While comparison of two measures of performance is described herein, the data aggregator 455 can generate any number of such measures of performance of the agent using the same policy or a different policy (e.g., policies varying in parameters based on which agents chose a (state, action) pair and/or hyperparameters based on which agents learn and modify behavior such as learning rate, future reward discount, epsilon greedy threshold, different time periods, different contexts, different environments, different starting states, different behavioral strategies used (e.g., using temporal abstractions, options, synthetic states, etc.), using different ML models (e.g., using different approaches to decision making, or using different model architectures, etc.) and/or the like).

The processor 451 includes an agent manager 456 that can be configured to generate and/or manage one or more agents configured to interact with an environment and/or implement machine learning. An agent can refer to an autonomous entity that performs actions in an environment or world that is modeled or set up according to a set of states or conditions and configured to react or respond to agent actions. An environment or world can be defined as a state/action space that an agent can perceive, act in, and receive a reward signal regarding the quality of its action in a cyclical manner (illustrated in FIG. 2A). An AM system can define a dictionary of agents including definitions of characteristics of agents, their capabilities, expected behavior, parameters and/or hyperparameters controlling agent behaviors, etc. An AM system can define a dictionary of actions available to agents. In some implementations the actions available to an agent can depend and/or vary based on the environment or world in which the agent acts. As an example, a world can be modeled using parameters associated with financial trading, livestock management, autonomous operation of instrumentation, autonomous driving, speech generation, and/or the like, and can use reward signals derived based on a set of tasks and/or goals in each respective environment. In some implementations, an agent manager 456 can use returns of an investment portfolio in a financial trading environment to define reward signals, or animal health and animal number measures obtained from analysis of samples of bioproducts and/or secretions obtained from animals in a livestock management environment, and so on, to define reward signals.

In some implementations, an environment or world can be defined to include state/action pairs associated with an environment's context. For example, a context of an environment can include real world trading or investment variables, such as, for example, monitoring stocks, trading on stocks, selecting companies or organizations whose stock to track and invest in, making decisions to buy, wait and/or sell, switch investment strategies on stocks, bonds, and/or the like between risky and safe strategies etc., responding to unexpected turns in the economy in the natural world (e.g., a pandemic) or state of an individual stock value (e.g., drastic drop or increase on valuation of a company) and/or the like. The agent can be responsible to manage an investment portfolio and can be tasked with maximizing and/or increasing returns on investment. As another example, a context of an environment can include livestock management variables, such as, for example, assignment of livestock to groups, providing or administering feeds or feed blends of animals in groups of livestock, obtaining data from individual animals indicating health status and/or a reproductive property associated with health status, obtaining bioproducts from animals in the groups, analyzing the contents of bioproducts produced by individual animals in a group, providing recommendations of schedules including a selection of feed blend/medicinal treatment/dietary supplement to individual animals in a group, administering feed blend/medicinal treatment/dietary supplement to individual animals in a group, responding to unexpected turns in health status and/or change in quantity or quality of bioproduct, and/or the like. Through this cyclical interaction, agents can be configured to learn to automatically interact within a world intelligently without the need of a controller (e.g., a programmer) defining every action sequence that the agent takes.

In an example implementation, agent-world interactions can include the following steps. An agent observes an input state. An action is determined by a decision-making function or policy (which can be implemented by an ML model 457). The action is performed via the agent manager 456. The agent receives a reward or reinforcement from the environment in response to the action being performed. Information about the reward given for that state/action pair is recorded. The agent can be configured to learn based on the recorded history of state/action pair and the associated reward. Each state/action pair can be associated with a value using a value function under a specific policy. Value functions can be state-action pair functions that estimate how favorable a particular action can be at a given state, or what the return for that action is expected to be. In some implementations, the value of a state (s) under a policy (p) can be designated V^{p}(s). A value of taking an action (a) when at state (s) under the policy (p) can be designated Q^{p}(s,a). The goal of the AM device 405 can then include estimating these value functions for a particular policy. The estimated value functions can then be used to determine sequences of actions that can be chosen in an effective and/or accurate manner such that each action is chosen to provide an outcome that improves and/or maximizes total reward possible, after being at a given state.

In some implementations, each agent can be associated with a state from a set of states that the agent can assume. For example, in a financial environment, a set of state values can include indicia that indicate a set of stocks whose value has changed from a prior value and can be used for trading. Such an indication can cause the agent to switch the trading position or strategy adopted. As another example, in a livestock management environment, state values can be the somatic cell and urea counts that may have increased from a previous record and indicate that the animals are experiencing health issues because the reward value has decreased. Such an indication can cause the agent to change the feed or select medicinal treatment to be applied. Each agent can be configured to perform an action from a set of actions. The agent manager 456 can be configured to mediate an agent to perform an action, the result of which transitions the agent from a first state to a second state. In some instances, a transition of an agent from a first state to a second state can be associated with a reward. For example, an action of making a trade by selling some identified stocks can result in a reward in the form of profit on the trade, or providing a dietary and/or medicinal supplement can result in a reward in the form of an increase in a protein content associated a milk produced by a cohort of animals of livestock. The actions of an agent can be directed towards achieving specified goals. An example goal can be maximizing returns on investment in a financial environment. As another example, a goal can be collectively improving a health status and a bioproduct quality of an animals of a cohort of animals. The actions of agents can be defined based on observations of states of the environment obtained through data aggregated by the data aggregator 455 from compute devices or sources related to the environment (e.g., from investment related data sources, data bases, etc., sensors related to livestock management, etc.). In some instances, the actions of the agents can inform actions to be performed via actors (e.g., human or machine actors or actuators). In some instances, the agent manager 456 can generate and/or maintain several agents. The agents can be included in groups defined by specified goals. In some instances, the agent manager 456 can be configured to maintain a hierarchy of agents that includes agents defined to perform specified tasks and sub-agents under control of some of the agents.

In some instances, agent manager 456 can mediate and/or control agents to be configured to learn from past actions to modify future behavior. In some implementations, the agent manager 456 can mediate and/or control agents to learn by implementing principles of reinforcement learning. For example, the agents can be directed to perform actions, receive indications of rewards and associate the rewards to the performed actions. Such agents can then modify and/or retain specific actions based on the rewards that are associated with each action, to achieve a specified goal by a process directed to increase the number of rewards. In some instances, such agents can operate in what is initially an unknown environment and can become more knowledgeable and/or competent in acting in that environment with time and experience, and automatically update hyperparameters to improve and/or maximize rewards as described herein. In some implementations, agents can be configured to learn and/or use knowledge to modify actions to achieve specified goals.

In some embodiments, the agent manager 456 can configure the agents to learn to update or modify actions based on implementation of one or more machine learning models, and/or to update a policy and/or hyperparameters based on evaluation measures of performance using suitable methods (e.g., using the Sharpe ratio as described herein). In some embodiments, the agent manager 456 can configure the agents to learn to update or modify actions based on principles of reinforcement learning. In some such embodiments, the agents can be configured to update and/or modify actions based on a reinforcement learning algorithm and/or model implemented by the ML model 457, described in further detail herein.

In some implementations, the agent manager 456 can generate, based on data obtained from the data aggregator 455, a set of input vectors that can be provided to the ML model 457 to generate an output that determines an action of an agent. In some implementations, the agent manager 456 can generate input vectors based on inputs obtained by the data aggregator 455 including data received from compute devices and/or other sources associated with an investment portfolio, or a managed livestock and/or the like as the environment may be. In some implementations, the agent manager 456 can generate the input vectors based on a target return on investment, in a financial environment, or a target balance between a quality of a bioproduct produced by a livestock, health status of an animal in the livestock and a cost associated with management of the livestock, in a livestock management environment, or the like. In some instances, the input vectors can be generated to reach specific target states. Target states can be defined in a short term and/or long term. A long-term target state in a financial trading environment can be to maximize and/or increase profits. In a livestock management environment for example, a long-term target can be maximizing and/or increasing profits from sale of bioproducts yielded by livestock. Short term target states can also be used. As an example, a target state can be and/or maintain a specific rate of returns or profits from investments or to reach or maintain a level of health status of livestock and/or the like. Other target states can be used to guide an agent in making decisions, such as a quantity of short terms profits, or a baseline rate of rewards, or maintaining a minimum amount of long term safeguards, in a financial environment, or using minimal resources to maintain healthy livestock or balancing a customer need of a bioproduct and the number of animals to be raised, in a livestock management environment and/or the like.

The ML model 457, according to some embodiments, can employ an ML algorithm and/or model to improve and/or optimize an agent's behavior to increase and/or maximize returns. As an example, for an agent deployed in a financial trading environment, the ML model 457 can be used to improve selection of companies, commodities, services, bonds to track and invest in, make decisions related to selling/buying stocks, frequency of trades, strategies to trade, changes in strategies based on market conditions, state of the economy, world events, other variable associated with the financial market, and/or the like. As an example, for an agent deployed in a livestock management environment, the ML model 457 can be used to improve and/or optimize a selection of schedules, feeds and/or medicines that can be used to obtain a desired health status of individual animals, a desired reduction in waste of resources, a desired property associated with a health status of animals in a livestock, a desired quality of bioproduct, and/or a cost associated with maintenance of a cohort of animals producing a bioproduct according to desired criteria. In some instances, for example, the ML model 457 can represent or simulate a virtualized world using various properties of the corresponding real world—for example, a financial trading world including trading platforms, trading variables associated with investment in stocks, bonds, currencies, commodities, services, and/or the like, market variables associated with the real world, etc., or a livestock management world where the livestock are used to yield a bioproduct (e.g., milk) and animal health (e.g., instances of leaked resources, illness, longevity, reproduction, etc.). The ML model 457 can use reward signals derived based on tasks defined to achieve target results such as a target profit from trading or a target bioproduct yield/health status of animals that produce a bioproduct, and/or the like. The ML model 457 can be used to generate actions that are likely to lead to favorable results which may then be translated to the real world via human and/or machine actors.

The ML model 457 can include any suitable architecture implementing any suitable modeling algorithm or principle. In some instances, the ML model 457 can implement a reinforcement learning algorithm to determine action that can be undertaken by agents in a virtualized environment to arrive at predictions of indications of an actions that can increase a probability or likelihood of achieving a specified goal. The goal can be a specific target state in the short term and/or long term as described herein.

The ML model 457 can implement any suitable form of learning such as supervised learning, unsupervised learning and/or reinforcement learning. The ML model 357 can be implemented using any suitable modeling tools including statistical models, mathematical models, decision trees, random forests, neural networks, etc. In some embodiments, the ML model 357 can implement one or more learning algorithms. Some example learning algorithms that can be implemented by the ML model can include Markov Decision Processes (MDPs), Temporal Difference (TD) Learning, Advantage Actor-Critic (A2C), Asynchronous Advantage Actor-Critic (A3C), Deep Q Networks (DQNs), Deep Deterministic Policy Gradient (DDPG), Evolution Strategies (ES) and/or the like. The learning scheme implemented can be based on the specific application of the task. In some instances, the ML model 357 can implement Meta-Learning, Automated Machine Learning and/or Self-Learning systems based on the suitability to the task.

The ML model 457 can be configured such that the ML model 457 receives input vectors and generates an output based on the input vectors. In some implementations, the output can indicate the action choice to be implemented or a policy choice to be implemented by an agent.

The ML model 457 can incorporate the occurrence of rewards and the associated inputs, outputs, agents, actions, states, and/or state transitions in the scheme of learning. The ML model 457 can be configured to implement learning rules or learning algorithms such that upon receiving inputs indicating a desired goal or trajectory that is similar or related to a goal or trajectory that was achieved or attempted to be achieved in the past, the ML model 457 can use the history of events including inputs, outputs, agents, actions, state transitions, and/or rewards to devise an efficient strategy based on past knowledge to arrive at the solution more effectively.

In some embodiments, the ML model 457 can be trained using training data that can be derived from any suitable source based on the environment and/or a context associated with the environment in which the agent is to be deployed. In some implementations, the agent can be trained to navigate a training environment and accumulate knowledge that can be used in a test (e.g., real world) environment. As an example, the ML model 457 and/or the agent associated with the ML model 457 can be trained in a financial training environment based on training data obtained from a previous economic context, condition or environment that might be expected to be associated with an economic context, condition or environment in which the agent is to be deployed.

While an ML model 457 is shown as included in the AM device 405, in some embodiments, the ML model 457 can be omitted. In some implementations, the AM device 405 can implement a model free reinforcement learning algorithm to implement agents and their actions and learning, based not on a model but, for example, on trial and error from interacting with the environment. A model-free algorithm (as opposed to a model-based one) can be any suitable algorithm that does not use a transition probability distribution (or a reward function) associated with the Markov decision process (MDP), which represents the task to be accomplished upon navigation of an environment. A model-free RL algorithm can be implemented as an “explicit” trial-and-error algorithm. An example of a model-free algorithm is Q-learning.

In some implementations, the ML model 457 and/or the agent manager 456 can implement hierarchical learning (e.g., hierarchical reinforcement learning) using multiple agents undertaking multi-agent tasks to achieve a specified goal. For example, a task can be decomposed into sub-tasks and assigned to agents and/or sub-agents to be performed in a partially or completely independent and/or coordinated manner. In some implementations, the agents can be part of a hierarchy of agents and coordination skills among agents can be learned using joint actions at higher level(s) of the hierarchy.

In some implementations, the ML model 457 and/or the agent manager 456 can implement temporal abstractions in learning and developing strategies to accomplish a task towards a specified goal. Temporal abstractions can be abstract representations or generalizations of behaviors that are used to perform tasks or subtasks through creation and/or definition of action sequences that can be executed in new and/or novel contexts. Temporal abstractions can be implemented using any suitable strategy including an options framework, bottleneck option learning, hierarchies of abstract machines and/or MaxQ methods.

The outputs of the ML model 457 can be provided to the agent manager 456. In some implementations, the agent manager 456 can be further configured to receive outputs from the ML model 457 and based on the outputs make predictions that can be tested in the real world. For example, the agent manager 456 can receive outputs of ML model 457 and generate a prediction of achieving a specified target goal defined for an environment or a value/improvement in an aspect of the environment. Aspects can include profits, trading position, etc. for an agent in a financial trading environment or a target health status, target bioproduct quality, a target reduction in production loss, and/or a target reduction/maintenance in costs associated with animal handling in a livestock management environment, and/or the like. In some embodiments, goals can include a target balance between two or more of these aspects and/or a collective improvement in two or more aspects. In some instances, the prediction can be based on outputs of ML model 457 that a goal may be achieved within a specified duration of time following the implementation of a policy change or action selection based on the outputs of the ML model 457. In some implementations, the agent manager 456 can provide several predictions that can be used to recommend, select and/or identify a strategy to be implemented in the real world.

The processor 451 includes a parameter tuner 458. The parameter tuner 458 can be configured to receive measures of performance and/or ratios comparing measures of performance from the data aggregator 455. The parameter tuner 458 can evaluate the performance of one or more agents identified or associated by the measures of performance and based on measures of performance and/or the ratios comparing the measures of performance, can determine whether the agent is operating using a desirable behavior strategy and/or learning strategy under an identified policy. The parameter tuner 458 can determine if one or more parameters and/or hyperparameters associated with the identified policy can be updated to a new value to increase the likelihood of the agent reaching a target state and/or to maximize rewards or returns. For example, the parameter tuner 458 can evaluate a Sharpe ratio received from the data aggregator 455. The Sharpe ratio can be a difference between a first measure of performance, that is an expected value of rewards associated with an agent's interactions with the environment according to the first policy, and a second measure of performance, that is an expected value of rewards associated with the agent's interactions with the environment according to the second policy, and a standard deviation of the rewards associated with the agent's interactions with the environment according to the first policy. The second policy can be selected such that the second policy is associated with greedy interactions of the agent with the environment, with a value ε for the hyperparameter epsilon that is below a predefined threshold value.

The parameter tuner 458 can evaluate a Sharpe ratio by comparing the value associated with the Sharpe ratio to predefined thresholds that indicate a certain performance of the agent under the first policy compared against a risk-free behavior under the second policy with the value ε for the hyperparameter epsilon that is below a predefined threshold value. The Sharpe ratio, as used in finance, can compare the rate of return of portfolios to the return of a risk-free asset such as treasury bills. For RL applications there does not exist a concept of risk-free rate of return. Here, the system and methods described take advantage of the Sharpe ratio to estimate an analogue of risk-free rate of return by the average reward of the agent when they take greedy actions. The rationale behind this is that the agent using the greedy actions under the greedy policy is performing actions that it considers to be best, thus optimal. The Sharpe ratio can be computed by the data aggregator 455 over a sliding window of recent history, the average of this value can be used as the risk-free rate of the agent. As an example, the parameter tuner 458 can have predefined threshold values of 0, 0.5, 1.0, 1.5, etc. The parameter tuner 458 can interpret that the greater a given Sharpe ratio, the better the performance under the first policy compared to a risk-adjusted performance. A negative Sharpe ratio can be interpreted to mean that the relatively risk-free second policy which is being used as a benchmark is greater than the agent's performance under the first policy within the identified time window, or that the agent's first policy is expected to generate suboptimal and/or negative returns. The Sharpe ratio can also be used when the agent is set to operate under a risky first policy to estimate whether the risk taken was worth the returns collected. In some instances, the parameter tuner 458 can compare the Sharpe ratio for a given time window and for a given first policy and determine that the first policy is suitable for the current conditions and not alter any hyperparameters. Alternatively, in some instances, the parameter tuner 458 can determine that the Sharpe ratio is below a predefined threshold and interpret that to mean that the first policy is to be updated. The parameter tuner 458 can tune one or more parameters and/or hyperparameters, automatically, for example, in response to the Sharpe ratio evaluation, to generate a new policy, e.g., a third policy. The agent may be operating under the first policy associated with a set of current values, each current value from the set of current values being associated with a parameter or a hyperparameter. The parameter tuner 458 can automatically adjust at least one current value from the set of current values to generate a new policy that can be provided to the agent manager 456 for the agent to follow for future interactions with the environment. For example, the parameter tuner 458 can adjust a hyperparameter including, for example, lambda associated with a learning rate, gamma associated with discount of future rewards, or epsilon associated the coefficient of greediness.

In use, the AM device 405 can receive inputs from one or more compute devices and/or data sources using a data aggregator 455. The inputs can include information regarding the environment in which one or more agents are deployed by the AM device, for example, a financial trading environment, a livestock managing environment, an autonomous manipulation of instrumentation or autonomous navigating of automobiles, speech generation, playing probability-based games (e.g., the game illustrated in FIG. 3) and/or the like. The AM device 405 can implement virtualized agents acting within a virtualized world or environment, using an agent manager 456 and/or an ML model 457. In some implementations, the environment can be defined in a form of a Markov decision process. For example, the environment can be modeled to include a set of environment and/or agent states (S), a set of actions (A) of the agent, and a probability of transition at a discreet time point (t) from a first state (S1) to a second state (S2), the transition being associated with an action (a).

In some implementations, the agents and/or the world can be developed based on one or more inputs or modified by one or more user inputs. The data aggregator 455 of the AM device 405 can provide aggregated information to the ML model 457. In some embodiments, the agent(s) can be part of the ML model 457. In some embodiments, the ML model 457 can implement the environment in which the agent(s) are configured to act. In some instances, the AM device 405 can receive an indication of a change in a property or context associated with the real world, which can be realized as a change in property associated with the virtualized world modeled by the AM device 405. The indication may include a positive increase in a property and/or parameter relevant to the agent (e.g., an increase in potential profits from sale of stock at a new value, a recovery from illness, a successful generation of speech, etc.). The indication can also be indicative of a negative change in the world. In some instances, the AM device 405 can receive an indication of a current state of the world. In some implementations, the AM system 405 can predict and/or generate estimated rewards associated with identified actions selected from a set of actions available to the agent at a given state. The predicted estimated rewards can be used as predictions to be compared with reward signals received based on a state of a world or environment. The AM system 405 can be configured to learn and/or update the ML model 457 and/or the agent and its behavior based on the rewards received and/or a comparison between the estimated reward and an actual reward received from the world. Over time and/or over a course of implementation of the virtualized environment/agents, the AM device 405 can generate an output based on the information received. The output of the ML model 457 can be used to generate a prediction of an outcome or an event or a recommendation of an event to achieve a desired goal. The AM device 405 can be configured to continuously, periodically, sporadically or in response to particular conditions (e.g., rewards greater than or lesser than identified threshold values) receive inputs from the environment related to agent behavior and evaluate agent performance on a sliding temporal window associated with prior history where the agent used a first policy to govern interactions with the environment. The length or duration or placement of the temporal window for prior history can be defined using any suitable method by the AM device 405 or set by a user and/or a combination of preset values by user that is updated by the AM device 405.

Duration and placement of the temporal window can also be based on the environment in which the agent is deployed, a natural cycle of decision making in that environment, statistics and/or or temporal scale of expected non-stationarities associated with the environment, and/or the like. The placement of the window can be periodic or based on user response, or on a sliding window manner, such that the past is constantly being monitored as the window slides in time. For example, in a financial trading environment, a duration of a temporal window can be based on an investment cycle, a financial year, a financial quarter, or alternatively can be on any other suitable time scale (e.g., weeks, days) to monitor changes based on one or more actions or events in the past. In a livestock management environment, the temporal window duration can be, for example, a year or a few years to monitor reproductive cycles of livestock or a financial year or quarter to monitor past performance (e.g., on a periodic, as desired, or continuous manner, etc.). In an automated equipment manipulation environment, the temporal window duration can be years or months of equipment function, alternatively days, minutes of equipment manipulation and results from the manipulation. In some implementations, the temporal window can also be seconds or microseconds to monitor fine motor control and manipulation of fine equipment to monitor success and failures. Temporal window placement can be periodic, as desired, sporadic and/or substantially continuous.

In some implementations, the evaluation of the agent performance under the first policy can be against a risk adjusted performance associated with a greedy behavior of the agent and the comparison can be using the Sharpe ratio. Based on the outcome of calculation of the Sharpe ratio the parameter tuner 458 can compare the Sharpe ratio against predefined threshold values and determine whether one or more of the current values associated with one or more parameters and/or hyperparameters is to be automatically adjusted and, if so, how much the adjustment should be. The identification of the one or more parameters and/or hyperparameters to be automatically adjusted and the determination of how much adjustment is desired can be based on past tuning of one or more parameters and/or hyperparameters in the same environment and the consequences of the adjustment or tuning that was recorded by the agent manager 456 and/or data aggregator 455. Similarly, the data aggregator 455 and/or the agent manager 456 can be configured to record the consequences in the agent's interactions and the environment resulting from the adjustment of the one or more parameters and/or hyperparameters. These events can be cyclically repeated to achieve the target state and/or the goal of increasing and/or maximizing rewards.

While the device 405 is described to have one each of a data aggregator, an agent manager, an ML model, and a parameter tuner, in some embodiments, a device similar to the device 405 can be configured with several instances of the above-mentioned units, components, and/or modules. For example, in some embodiments, the device may include several data aggregators associated with one or more compute devices or groups of compute devices. The device may include several agent managers generating and operating multiple agents as described in further detail herein. In some embodiments, the device may include several ML models or various architecture and/or configurations and/or several parameter tuners assigned to perform specified computations, predictions, and/or adjustments. In some embodiments, one or more of the components including a data aggregator, an agent manager, an ML model, and a parameter tuner can be omitted and/or combined with another component to perform related functions.

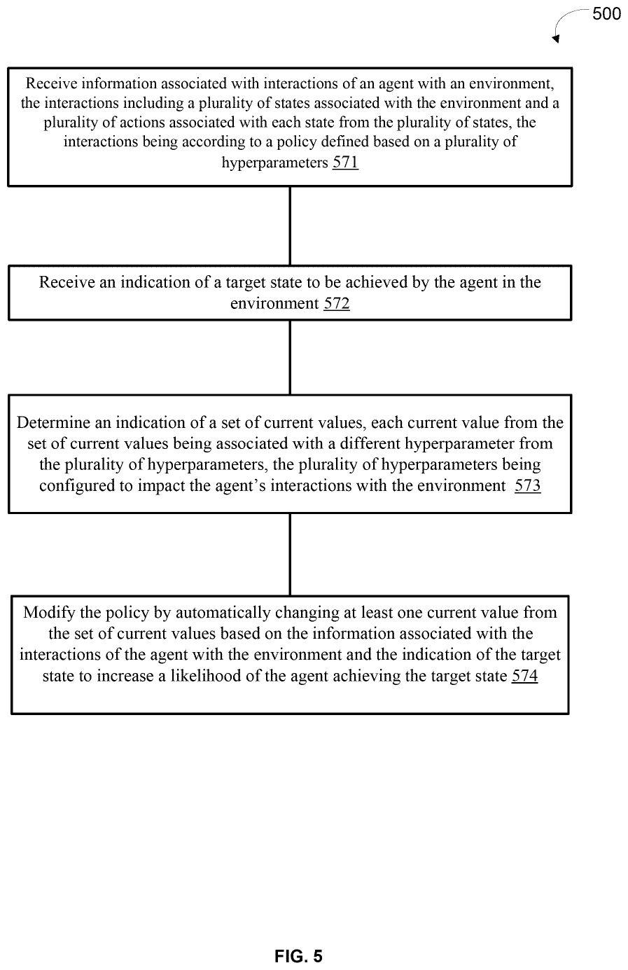

FIG. 5 illustrates an example method 500 of using the data received from the compute devices and/or data sources associated with an environment in which one or more agents are deployed to accomplish a task, and automatically updating and managing an agent's interactions with the environment, using an AM device as described herein, according to an embodiment. The method 500 can be implemented by an AM system similar in structure and/or function to any of the AM systems 100, 900 and/or the systems used with reference to details described in FIGS. 2A, 2B, 3A, 3B, and/or 4. In some embodiments, the method 500 can be implemented partially or fully by an AM device (e.g., a processor of an AM device) substantially similar in structure and/or function to the AM devices 105, and/or 405, described herein.

At 571, the method 500 includes receiving information associated with interactions of an agent with an environment, the interactions including a plurality of states associated with the environment and a plurality of actions associated with each state from the plurality of states, the interactions being according to a policy defined based on a plurality of hyperparameters. For example, the policy can be based on hyperparameters such as lambda (learning rate), gamma (discount of future rewards), epsilon (coefficient of greediness), etc. In some implementations, the policy can include parameters and/or features such as, for example, available states, actions per state, rewards and/or values associated with specific states, options, temporal abstractions, synthetic states, and/or the like.

The method 500, at 572 includes receiving an indication of a target state to be achieved by the agent in the environment. As an example, the environment may be a financial trading environment and the target state to be achieved can include a state of having received cumulative rewards or in some implementations the target state can be a state of improving and/or maximizing portfolio returns on investments. As another example, the environment can be a livestock management environment and the target state can be an identified quality and/or quantity of bioproduct yielded by the livestock or the target state can be a state of improving and/or maximizing profits from sale of the bioproduct considering the demand for the bioproduct and the costs associated with the maintenance and management of the livestock.

At 573, the method 500 includes determining an indication of a set of current values, each current value from the set of current values being associated with a different hyperparameter from the plurality of hyperparameters, the plurality of hyperparameters being configured to impact the agent's interactions with the environment. Said in another way, the policy according to which the agent interacts with the environment can be based on a set of hyperparameters, for example, hyperparameters such as lambda (learning rate), gamma (discount of future rewards), and/or epsilon (coefficient of greediness). Each hyperparameter can be associated with a current value such that the set of hyperparameters are defined based on a set of current values. The current value of each hyperparameter can be configured to impact agent behavior within the temporal window that the agent interacts with the environment based on the policy.

At 574, the method 500 includes modifying the policy by automatically changing at least one current value from the set of current values based on the information associated with the interactions of the agent with the environment and the indication of the target state to increase a likelihood of the agent achieving the target state. The policy can be modified by altering at least one current value of at least one of the hyperparameters such that the policy is modified to adopt a new strategy to navigate the environment. For example, the policy can be modified by changing the current value associated with the hyperparameter lambda indicating a learning rate associated with the agent. For example, the policy can be modified to increase or decrease learning rate, each altering the agents capacity to learn from current state changes. For example, the policy change be modified by changing a current value associated with the hyperparameter gamma indicating a measure of discount of future rewards. For example, the policy can be modified by increasing or decreasing the current value of gamma to decrease or increase the discount associated with future rewards, respectively. By increasing the current value of gamma, the agent can be made to evaluate current actions based not only on current expected rewards but also future rewards given the current trajectory. By decreasing the current value of gamma, the agent can be made to disregard future rewards and only focus on actions that generate immediate current rewards. As another example, the policy can be modified by changing the current value associated with epsilon, indicating a coefficient of greediness. By increasing the current value associated with epsilon the agent can be made to switch to a more exploratory behavior such that more trials or more actions are devoted to risk taking. By decreasing the current value of epsilon, the agent can be made to switch to a less exploratory and more exploitative behavior (or greedy behavior) where the agent takes the safer choice in actions.

In some implementations, the modification to the policy can be implemented automatically by an AM device, as described herein. In some implementations, the modification to the policy can be implemented automatically by the agent without involvement from a user. In some implementations, the policy changes can be made by other agents (e.g., a hierarchy of second agent, third agent, etc.) deployed that can be configured to manage the policy changes associated with a first agent.

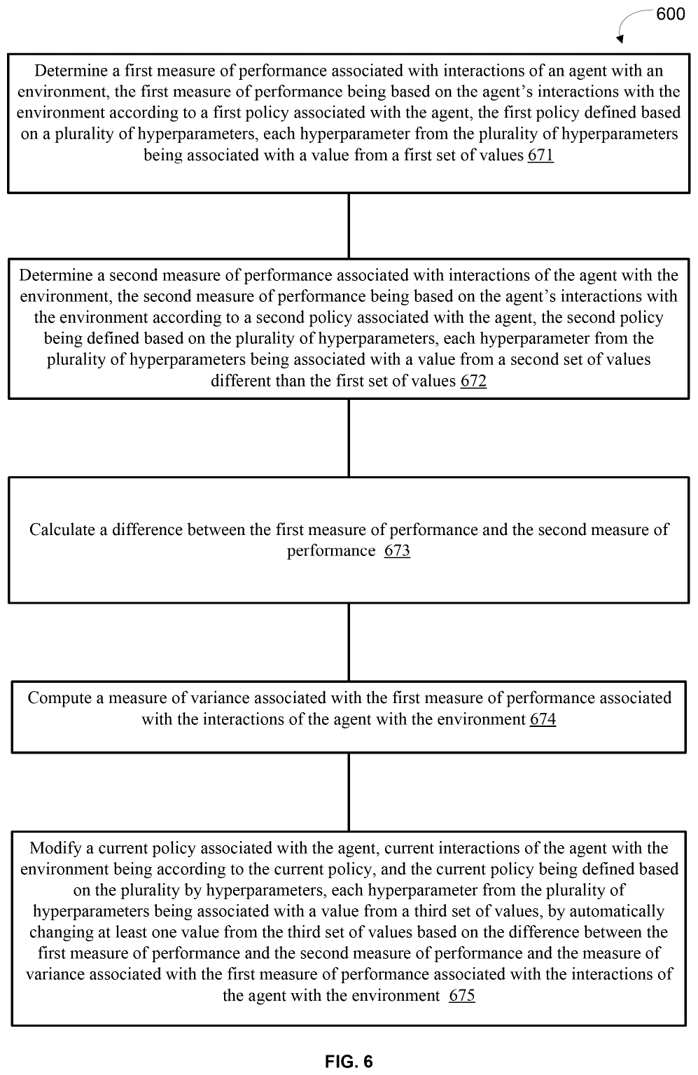

The policy modification can be based on measures of performance of the agent deployed in the environment. FIG. 6 illustrates an example method 600 of determining measures of performance associated with an agent which can be used to determine if a policy modification is desired to be instituted and if so, how can the policy be modified.

FIG. 6 illustrates an example method 600 of using the data received from the compute devices and/or data sources associated with an environment and automatically updating and managing an agent's interactions with the environment, using an AM device as described herein, according to an embodiment. In some implementations, the method 600 can be implemented with the method 500 described herein with reference to method 500.

The method 600 can be implemented by an AM system similar in structure and/or function to any of the AM systems 100, 900, systems used with reference to details described in FIGS. 2A, 2B, 3A, 3B, and/or 4. In some embodiments, the method 600 can be implemented partially or fully by an AM device (e.g., a processor of an AM device) substantially similar in structure and/or function to the AM devices 105, and/or 405, described herein. The method 600 illustrates a method to measure performance of an agent under two conditions, for example, under two different policies, under two different time windows, under two different environments or environment contexts, and/or the like. In some implementations, one of the two conditions can be used as a standard or a benchmark to compare with the other condition. In some implementations, the one benchmark condition can be used to compare several measures of performance against performance of the agent under the benchmark condition. One such example, comparison is illustrated in method 600 in FIG. 6.

At 671, the method 600 includes determining a first measure of performance associated with interactions of an agent with an environment, the first measure of performance being based on the agent's interactions with the environment according to a first policy associated with the agent, the first policy defined based on a plurality of hyperparameters, each hyperparameter from the plurality of hyperparameters being associated with a value from a first set of values. In some instances, the first measure of performance can be determined using data associated with the agent's interactions with the environment during an identified first time period or first temporal window. The first measure of performance can be indicative of the agent's performance under a first condition, in this example, a first policy. In some implementations, the first condition, which is the first policy in this example, can be a test condition or a test policy, that is to be evaluated. That is, the first measure of performance can be indicative of applicability of the first set of values associated with the plurality of hyperparameters. The first measure of performance can be any suitable metric that is indicative of the ability of the agent to navigate the environment using the first policy, learn the features of the environment, and collect rewards while avoiding negative results. In some implementations, the first measure of performance can be a measure of rewards received in the course of the interactions of the agent with the environment or a measure of any other reinforcing value, feature or quality perceived by the agent in the course of the interactions of the agent with the environment. For example, the environment can be a financial trading environment and the first measure of performance can be an expected portfolio return when the agent is operating under the first policy. That is, the rewards collected by the agent under the first policy can be a set of rewards (Rx) collected by performing actions based on the first policy and the expected portfolio return or the rate of return can be the set of rewards collected under the first policy divided by the count of rewards (Rxcount).

At 672, the method 600 includes determining a second measure of performance associated with interactions of the agent with the environment, the second measure of performance being based on the agent's interactions with the environment according to a second policy associated with the agent, the second policy being defined based on the plurality of hyperparameters, each hyperparameter from the plurality of hyperparameters being associated with a value from a second set of values different than the first set of values. For example, the second policy can include a set of hyperparameters of which at least one hyperparameter is associated with a different value than in the first policy. In some instances, the second measure of performance can be determined using data associated with the agent's interactions with the environment during an identified second time period or second temporal window. In some implementations, the second measure of performance can be indicative of the agent's performance under a second condition, in this example, a second policy. In some implementations, the second condition, which is the second policy in this example, can be a standard or benchmark condition or a standard or benchmark policy, that is to be used as a standard against which to compare other conditions, for example, policies, to evaluate the other conditions or policies, and the ability of the agent to navigate those conditions or use those policies for improved results. In some implementations, the second measure of performance can be a measure of rewards received in the course of the interactions of the agent with the environment or a measure of any other reinforcing value, feature or quality perceived by the agent in the course of the interactions of the agent with the environment under the second policy. For example, the environment can be a financial trading environment and the second measure of performance can be an expected portfolio return when the agent is operating under the second policy. That is, the rewards collected by the agent under the second policy can be a set of rewards (Rf) collected by performing actions based on the second policy and the expected portfolio return or the rate of return can be the set of rewards collected under the first policy divided by the count of rewards (Rfcount). As described herein, the second policy can be a standard or a benchmark policy. In some implementations, the second policy can be a greedy policy where the agent makes safe or risk adjusted decisions to choose actions that are safe or have a known current expected return. Said in another way, the second policy can be associated with greedy interactions of the agent with the environment, with the hyperparameter epsilon from the plurality of hyperparameter, indicating a coefficient of greediness, can have a value from the second set of values that is indicated to be below a predefined threshold value, according to the second policy.

At 673, the method 600 includes calculating a difference between the first measure of performance and the second measure of performance. In the example of a financial environment, the calculation of the difference is a difference between the expected portfolio return when employing the first policy (the test policy to be evaluated) and the expected portfolio return when employing the second policy (the standard or the benchmark policy such as, for example, a greedy policy with an identified upper limit or upper threshold for a value for epsilon).

At 674, the method 600 includes computing a measure of variance associated with the first measure of performance associated with the interactions of the agent with the environment. The measure of variance can be used to account for variability in the reward signal over time during the time window from which data is used for the evaluation of the first condition or first policy. For example, the variability associated with rewards received during interactions under the first policy can be accounted for by adjusting the difference between the first measure of performance and the second measure of performance based on the measure of variance.

At 675, the method 600 includes modifying a current policy associated with the agent, current interactions of the agent with the environment being according to the current policy, and the current policy being defined based on the plurality by hyperparameters, each hyperparameter from the plurality of hyperparameters being associated with a value from a third set of values, by automatically changing at least one value from the third set of values based on the difference between the first measure of performance and the second measure of performance and the measure of variance associated with the first measure of performance associated with the interactions of the agent with the environment. The modifying the current policy by automatically changing at least one value from the third set of values can be based on evaluating the current policy and identifying an improvement to be made to the current policy.

The evaluation and the modifying of the current policy can be based on any suitable metric, index, or measure derived based on the difference between the first measure of performance and the second measure of performance and the measure of variance associated with the first measure of performance associated with the interactions of the agent with the environment. As an example, the current policy can be evaluated using a Sharpe ratio, which is the ratio of the difference between the first measure of performance and the second measure of performance, and the measure of variance associated with the first measure of performance associated with the interactions of the agent with the environment. In some implementations, the Sharpe ratio can be calculated and compared against predefined threshold values that may be indicative of a degree of performance of the agent in the environment. For example, the Sharpe ratio calculation based on the ratio of the difference between the first measure of performance and the second measure of performance, and the measure of variance associated with the first measure of performance associated with the interactions of the agent with the environment can be compared against predefined threshold values for Sharpe ration such as threshold values 0.5, 1.0, 1.5, etc. In some instances, if for example, the calculated Sharpe ratio is greater than 1.5, such a comparison may indicate that the current policy is performing well and allows the agent to navigate the environment in a better manner compared to risk adjusted estimates of what rewards may be collected in that environment. In some such instances, the current policy may be sufficient for the near future and there may be no modifications desired in the current policy (i.e., the set of values associated with the plurality of hyperparameters may be left unchanged).

In some instances, if for example, the calculated Sharpe ratio is less than 0.5, such a comparison may indicate that the current policy is not operating as desired and does not allow the agent to navigate the environment in a desired manner as to take best advantage of what the environment has to offer in terms of rewards, when compared to risk adjusted estimates of what rewards may be collected in that environment. In some such instances, the current policy may be improved to correct agent behavior in the near future such that there is an increased likelihood of improving rewards or reaching any other identified target state. For example, modifications to the current value associated with one or more hyperparameters from the plurality of hyperparameters may update the first policy (e.g., the current policy) to an updated policy better suited for the agent to navigate the environment. The set of values associated with the plurality of hyperparameters may be automatically updated to target better performance from the agent. For example, a lambda value may be updated to increase a learning rate so that the agent may better understand a context associated with the environment and make better actions and/or choices that better fit the context of the environment. As another example, a gamma value may be decreased so that an agent may discount future rewards more and divert increased focus on immediate rewards (e.g., if the current context of an environment appears less risk prone and permissible for a greater number of actions that reap immediate rewards). As another example, an epsilon value may be increased to increase exploratory behavior (e.g., if a current context of an environment appears safe and/or relatively stationary) to increase rewards. Alternatively, an epsilon value may be decreased to make the agent choose less risky actions (e.g., if a current context of an environment is perceived to be less safe and/or relatively highly non-stationary).

As described previously, in some implementations, the evaluation of policies and/or contexts of environments can be done continuously, for example, using data from sliding time windows of recent past including data from the agents interactions with the environment in its recent history. The results of evaluation and/or modifications can be stored for later retrieval and comparison. The consequences of modifications may also be stored in association with the modifications for later retrieval, analysis, and/or repeated use. For example, certain modifications adopted for certain contexts of an environment (e.g., economic downturn) may prove to better improve agent behavior that may be reused when similar circumstances or contexts are perceived to reappear at a later time in the environment (e.g., a similar economic downturn occurring at a later time). In some such circumstances, the agent may perceive a change in the features of the environment and automatically update one or more current values associated with the plurality of hyperparameters even preemptively, thereby avoiding incurring any losses that may otherwise be inevitable.

In some embodiments, the disclosed AM systems and/or methods can include implementation of cognitive learning in the learning of agent-world interactions. In some implementations, an AM system can be implemented based on a hierarchical cognitive architecture as described, and/or using a hierarchical learning algorithm by an AM Device (e.g., AM Device 105 and/or 405) or a compute device (e.g., compute device 101-102,) as described herein. A hierarchical reinforcement learning algorithm can be configured to decompose or break-up a reinforcement learning problem or task into a hierarchy of sub-problems or sub-tasks. For example, higher-level parent-tasks in the hierarchy can invoke lower-level child tasks as if they were primitive actions. Some or all of the sub-problems or sub-tasks can in turn be reinforcement learning problems. In some instances, an AM system as described herein can include an agent can include many capabilities and/or processes including Temporal Abstraction, Repertoire Learning, Emotion Based Reasoning, Goal Learning, Attention Learning, Action Affordances, Model Auto-Tuning, Adaptive Lookahead, Imagination with Synthetic State Generation, Multi-Objective Learning, Working Memory System, and/or the like. In some embodiments, one or more of the above listed capabilities and/or processes can be implemented as follows.
(i) Repertoire Learning-Options learning can create non-hierarchical behavior sequences. By implementing repertoire learning hierarchical sequences of options can be built that can allow and/or include increasingly complicated agent behaviors.
(ii) Emotion Based Reasoning-Emotions in biological organisms can play a significant role in strategy selection and reduction of state-spaces improving the quality of decisions.
(iii) Goal Learning-Goal learning can be a part of the hierarchical learning algorithm. Goal learning can be configured to support the decision-making process by selecting sub-goals for the agent. Such a scheme can be used by sub-models to select action types and state features that may be relevant to their respective function.
(iv) Attention Learning-Attention learning can be included as a part of the implementation of hierarchical learning and can be responsible for selecting the features that are important to the agent performing its task.
(v) Action Affordances-Similar to Attention learning, affordances can provide the agent with a selection of action types that the agent can perform within a context. A model implementing action affordances can reduce the agent's error in behavior execution.
(vi) RL Model Auto-Tuning—This feature can be used to support the agent to operate in diverse contexts by changing contexts via auto-tuning altering the way in which a model is implemented.
(vii) Adaptive Lookahead-Using a self-attention mechanism that uses prior experience to control current actions/behavior, the adaptive lookahead can automate the agent search through a state space depending on the agent's emotive state and/or knowledge of the environment. Adaptive lookahead can improve the agent's computational use by targeting search to higher value and understood state spaces.
(viii) Imagination with Synthetic State Generation-Synthetic state generation can facilitate agent learning through the creation of candidate options that can be reused within an environment with the agent not having to experience the trajectory first-hand. Additionally, synthetic or imagined trajectories including synthetic states can allow the agent to improve its attentional skills by testing selection implementation of different feature masks such as attention masks.
(ix) Multi-Objective Learning-Many real-world problems can possess multiple and possibly conflicting reward signals that can vary from task to task. In this implementation, the agent can use a self-directed model to select different reward signals to be used within a specific context and sub-goal.
(x) Working Memory System—The Working Memory System (WMS), can be configured to maintain active memory sequences and candidate behaviors for execution by the agent. Controlled by the executive model (described in further detail herein), WMS facilitates adaptive behavior by supporting planning, behavior composition and reward assignment.

These capabilities and/or processes can be used to build systems that function with 98% less training data while realizing superior long-term performance.

In some embodiments, the systems and/or methods described herein can be implemented using quantum computing technology. In some embodiments, systems and/or methods can be used to implement, among other strategies, Temporal Abstraction, Hierarchical Learning, Synthetic State and Trajectory Generation (Imagination), and Adaptive Lookahead.

Temporal Abstraction is a concept in machine learning related to learning a generalization of sequential decision making. An AM system implementing a Temporal Abstraction System (TAS) can use any suitable strategy including an options framework, bottleneck option learning, hierarchies of abstract machines and/or MaxQ methods. In some implementations, using the options framework, an AM system can provide a general-purpose solution to learning temporal abstractions and support an agent's ability to build reusable skills. The TAS can improve an agent's ability to successfully act in states that the agent has not previously experienced before. As an example, an agent can receive a specific combination of inputs indicating a sequence of states and can make a prediction of a trajectory of states and/or actions that may be different from its previous experience but effectively chosen based on implementing TAS. For example, an agent operating in an AM system simulating a world involving the management of livestock can receive, at a first time, inputs related to a health status of a cohort of animals on a predefined feed. The agent can be configured to interact with the world such that the AM system can predict a progress in health status and/or a yield of bioproduct, even if the prediction is different from the agent's past experience, based on implementing TAS. The prediction can include a recommendation of feed selection or feed schedule to increase a likelihood of achieving a predicted result (e.g., health status/yield). Another example includes agents operating in financial trading models that can use TAS to implement superior trading system logic.

The TAS can support generalization of agent behavior. The TAS can also support automatic model tuning where agents/agent actions can be used to automatically adjust agent hyperparameters that affect learning and environment behaviors/interactions. For example, in some embodiments of an AM system, parameters involved in reinforcement learning include parameters used in Q-value update such as a learning rate λ, a discount factor associated with weight of future rewards γ, and a parameter to balance between exploration and exploitation by choosing a threshold value ε, as described herein. These parameters can be implemented as hyperparameters that can be defined to be associated with an agent such that a specified change in a hyperparameter can impact the performance of the model and/or the agent in a specified manner, as described in sections above. In some instances, a specified change in a hyperparameter can for example modify an agent from a practiced behavior to an exploratory behavior. An agent and/or a model can learn a set dependencies associated with hyperparameters such that a hyperparameter can be automatically tuned or modified in predefined degrees to alter agent behavior and/or model behavior.

When using the systems and methods described herein, that allow autotuning the AM system, developers no longer have to iterate on finding model configurations with good convergence. The model can support contextually adaptive hyperparameter values depending on how much the agent is aware about the current context and/or the environment's changing reward signal. Working in concert, the agent learns reusable strategies that are context sensitive allowing the agent to support adaptive behavior over time while enabling the agent to balance explorative/exploitative behaviors.

As described previously, embodiments of an AM system described herein can implement temporal abstraction in the virtualization of a world and/or agents to implement temporally extended courses of action, for example, to determine a recommended protocol of animal handling to meet demands on production of bioproducts based on end-use. Disclosed herein is a method to recursively build and improve temporal abstractions also referred to as options and hierarchical Q-Learning states to facilitate learning and action planning of reinforcement learning based machine learning agents.

In some implementations, an AM system can build and define a library or dictionary of options that can be used and/or reused partially and/or fully at any suitable time in any suitable manner. Learning temporal abstractions for example, skills and hierarchical states that can applied to learning can enable an AM system to learn to respond to new stimuli in a sophisticated manner that can be comparable or competitive to human learning abilities. The disclosed method provides an approach to automatically construct options and/or automatically constructing hierarchical states efficiently while controlling a rate or progress and/or growth of a model through the selection of salient features. When applied to reinforcement learning agents the disclosed method efficiently and generally solves problems related to implementing actions over temporally extended courses and improves learning rate and ability to interact in complex state/action spaces.

A temporal abstraction can be implemented by generating and/or using options that include sequences of states and/or sequences of actions. The implementation of options can be based on generating and adopting reusable action sequences that can be applied within known and unknown contexts of the world implemented by an AM system.

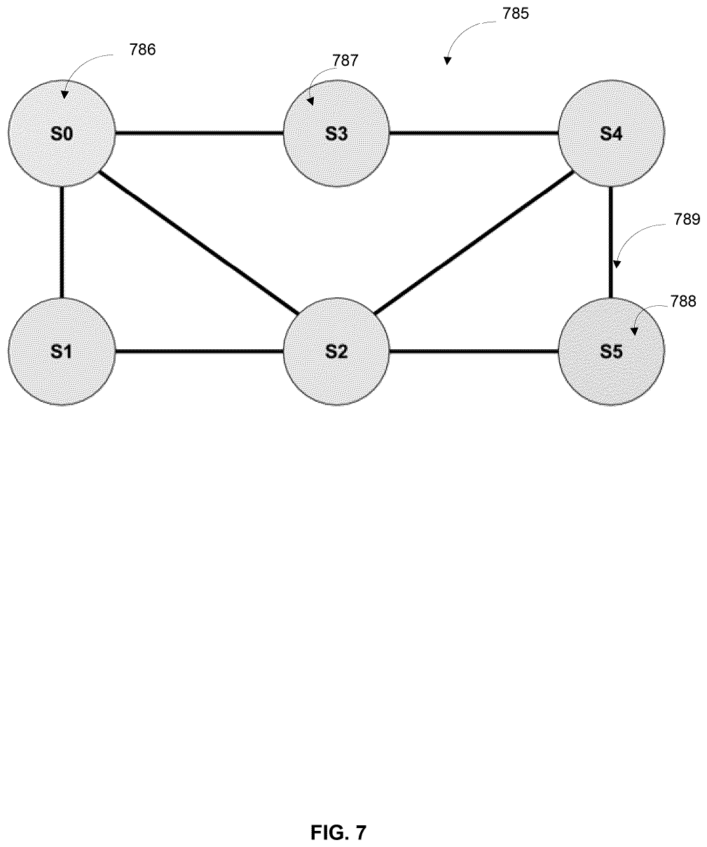

An example option 785 is illustrated in FIG. 7. An option can be defined by a set of initiation states (S0) 786, action sequences 789 involving intermediary states (S1, S2, S3, S4) 787, and a termination probability associated with a termination state (S5) 788. When an option 785 is to be executed, the agent can be configured to first determine its current state and if any of the available options offers to have a start state that is similar to its current state. If there is a positive identification of an option that includes a start state the same as its current state, the agent can then execute the sequence of predefined actions for the new states included in the option until the agent reaches the termination state and the termination probability condition is set to true. For example, the agent can identify start state (S0) 786 to be similar to a current state and identify the option 785 as a selection to be executed. In some instances, the option 785 can then be executed by the agent starting at the start state 786 and progressing through intermediary states S1-S2-S5, via actions indicated by the lines joining the respective states, to reach the termination state S5 788. In some instances, the agent can execute the option 785 by starting at the start state S0 786 and progressing through state S2 alone, or through states S2-S4, or through states S3-S4 indicated by lines representing actions, to reach the termination state S5 788. At state S5 the option terminates and the agent proceeds to select another action or option as dictated by agent behavior designed by an agent manager and/or by outputs from an ML model.

In some instances, AM systems described herein can implement hierarchical states in reinforcement learning that can play a role in improving agent learning rate and/or in the development of long-term action plans. In some instances, with an increase in complexity of a task (e.g., increase in number of alternative solutions, increase in dimensionality of variable to be considered, etc.) the trajectory to the solution can become intractable due to exponentially increasing complexity of agent actions due to an increase in the number of states in the system. In some implementations, the AM system can implement hierarchical states, which decrease the size of a state space associated with an AM system. This implementation of hierarchical states and the resulting decrease in state space can lead to an exponential decrease in a time for learning in agents. Automatic learning of hierarchical states in conventional systems, however, can represent challenges by restricting size of models that can be used.

In some embodiments, an AM system can be configured that can learn options and generate and use hierarchical states effectively using a recursive execution of a process associated with a Bellman Optimization method as described herein. The recursive process can be configured to converge on optimal and/or improved values over a period of time. The method can allow for the agent to select improved and/or optimal policies (e.g., actions resulting in state transitions) in known and unknown environments and update their quality values over time. In some instances, the method can treat options and hierarchical states as functionally dependent at creation and can allow for the merging of existing options and hierarchical states to build new state and action compositions. Over time, as the agent explores the state space, the algorithm can generate new hierarchical states and composition hierarchical states as the agent performs numerous trajectories through the state/action space.

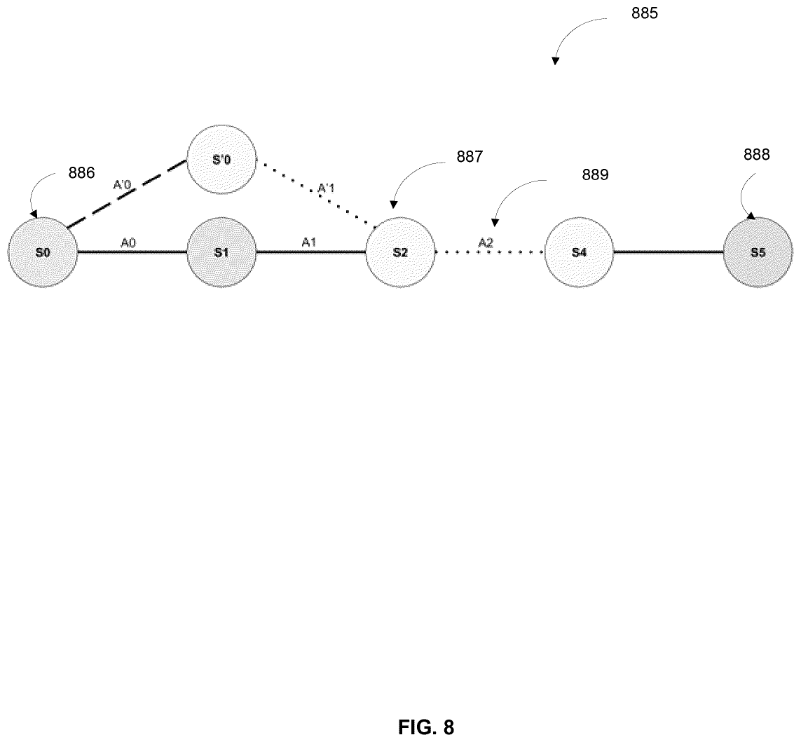

FIG. 8 is an illustration of an example option 885 and including hierarchical states (e.g., S′0) generated by an AM system, according to an embodiment. The option 885 can include a start state 886, intermediary states 887 and termination state 888. An example method adopted by the AM system can include building hierarchical states (e.g., S′0) and generating options (e.g., S2-S4, 889).

To build a hierarchical state, the AM system can first identify two consecutive state/action transitions through the world. The AM system can perform a sequence of verification steps including verifying that (1) the identified state/action transitions have non-zero Q^{p}(s,a) values (also referred to herein as Q values), which can be values associated with a state/action pair under a predefined policy, as defined previously, (2) the identified state/action sequence is non-cyclical, (3) that a sum of Q-values associated with the identified state/action transitions is at a percent value that is above a threshold value of interest (e.g., a threshold value set by a programmer/user), and (4) the transition sequence does not include a transition cycle from S0 to Sn.

Following the above steps, if positively verified, the AM system can continue to the next step and if not, the AM system can return to identifying two new consecutive state action transitions. If positively verified, the AM system can create and/or define a new hierarchical state S′, for example state S′0 as shown by S′0 in FIG. 8 and create and/or define a new state name (e.g., state X′). The new state can be associated with an action A′0 and an action A′1 as shown in FIG. 8.

The AM system can extract state primitives, and action primitives from standard and hierarchical state transitions. Based on the extracted information, the AM system can create and/or define a new hierarchical action from S0 state in sequence to the new hierarchical state S′0 (e.g., action A′0) and add the hierarchical action to a new hierarchical action associated with state S0. The AM system can create and/or define new hierarchical action from S′ (e.g., action A′1 from state S′0) to an intermediary state (e.g., S2) or a last state in sequence Sn (e.g., S5 in FIG. 8) and add the newly created and/or defined hierarchical action to an action list associated with state Sn. The AM system can then add state S′ (e.g., action A′0) to Q Model states. This new hierarchical state can be reached using normal planning and its Q value can be updated using the current system logic. In some instances, an AM system can be configured to implement and/or learn to implement state deletion. In some instances, an AM system can consider combining multiple options to create a repertoire behavior or a subset of an option action sequence that can include states previously generated by temporal abstraction algorithm, also referred to herein as hierarchical states. The AM system can be configured to learn to merge the two options to form a single option that builds hierarchical states from the two options. In some instances, the AM system can merge two options by selecting a set of hierarchical states and merging the action primitives to construct a new hierarchical state.

To generate an option, the AM system can initiate an induction cycle, in some implementations, to create and/or define a state name S′x (e.g., x=1, 2, . . . n) from action sequences by using action sequences extracted from hierarchical state algorithms. The AM system can identify an action A′x associated with the state S′x. The AM system can check that action A′x is not in a preexisting dictionary of options and that a sum of action Q values associated the action sequence including A′x is above a threshold value of interest. If the verification steps are indicated to be true (i.e., A′x is not in the dictionary of options and the sum of action Q values associated with the action sequence including A′x is above a threshold value) the AM system can continue, if not the system exits from induction cycle. If true, the AM system can create and/or define an option with an S0 state from hierarchical state induction sequence as initial initiation state or start state.

A method to construct hierarchical states can be implemented using reinforcement learning. The method can be associated with agents and can use pairwise state/action transitions to recursively optimize and/or improve action values using the Bellman Optimality Principle. In some implementations, the method can use a Q-value threshold to determine if a new hierarchical state is to be added to the model (e.g., reinforcement model). In some implementations, the method can include generating hierarchical states in a recursive manner from other hierarchical states.

A method to construct options/skills can be implemented using reinforcement learning. The method can be associated with agents and can use pairwise state/action transitions to recursively improve and/or optimize action values using the Bellman Optimality Principle. The method can use a Q-value threshold to determine if a new option/skill is to be added to the reinforcement model's options dictionary. In some implementations, the method can include generating hierarchical states associated with options/skills in a recursive manner from other hierarchical states.

In some implementations, the AM system can additionally support automatic merging of previously generated hierarchical states with new action trajectories or action sequences in a manner that can be consistent with an existing sequence of states/actions. This functionality can simplify a process of building and maintaining hierarchical states no matter how complex an environment is in a general and fully automatic algorithm. The disclosed AM systems and/or methods can thus reuse existing Q-Learning model insertion, update, and deletion mechanisms to manage hierarchical states. By using model update mechanisms of Q-Learning, selection of hierarchical states can help convergence to optimal and/or improved values over time according to the Bellman Optimality Principle. In some such implementations, the AM system thus combines sample efficient methods for the generation and merging of hierarchical states with mathematically mature methods to ensure that the quality of actions and options executed over time converge to optimal and/or improved values.

In some embodiments, the disclosed AM systems and/or methods can include implementation of cognitive or hierarchical learning in the learning of agent-world interactions. In some implementations, as described herein, an AM system can be configured to operate as a Hierarchical Learning System (HLS) that can implement a hierarchical learning algorithm that utilizes a recursively optimized collection of models (e.g., reinforcement learning models) to support different aspects of agent learning.

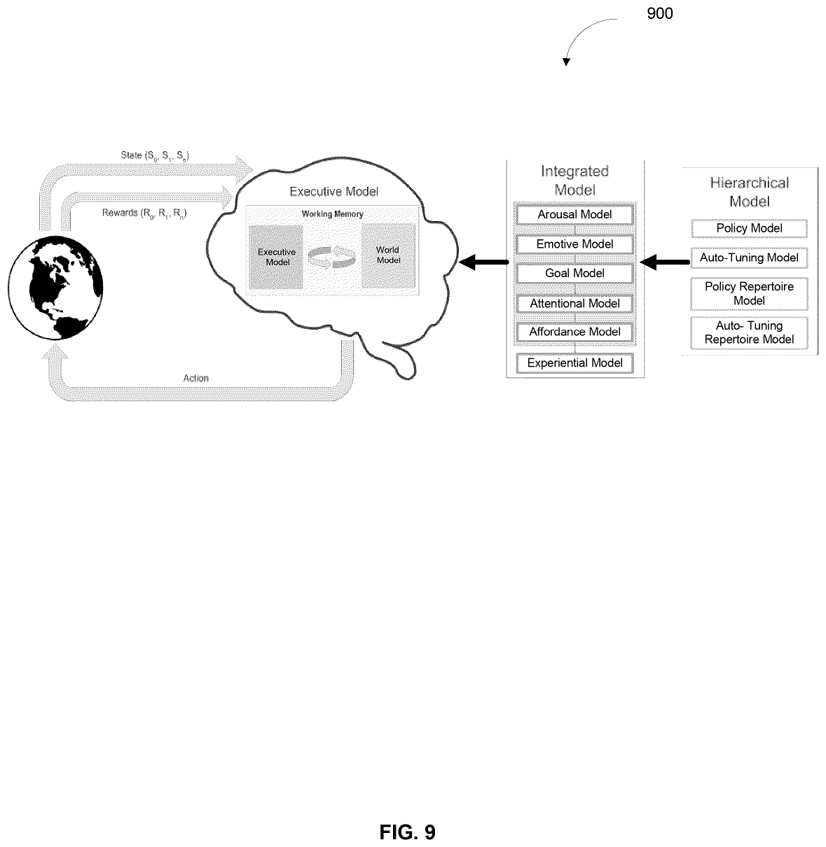

FIG. 9 illustrates a schematic representation of an AM system 900, implementing cognitive learning, according to an embodiment. The AM system 900 can be substantially similar in structure and/or function to the AM systems 100, and/or systems used with reference to details described in FIGS. 2A, 2B, 3A, 3B, and/or 4, and can implement methods similar to methods 500 and/or 600 described herein. In some embodiments, the cognitive learning in the AM system 900 can be implemented by an AM device substantially similar in structure and/or function to the AM devices 105, and/or 405, described herein.

In some implementations, a model (e.g., the ML model 457 described previously) in an AM system can include multiple models that in some instances, can be configured in a hierarchical organization. The AM system 900 can include an agent/system architecture as shown in FIG. 9, such that agent interactions with the world are based on a set of models including an executive model, an integrated model, and a hierarchical model. The world can have many states (S0, S1 . . . Sn) and states can be associated with rewards (R0, R1 . . . Rn). An agent can be defined to interact with the world via actions and the agent actions can have consequences including an impact on the state, changes in the state of the world, and/or rewards. The executive model can include a model simulating a working memory component. The working memory component can in turn include an executive model that is configured to simulate agent actions and a world model that is configured to simulate world states, state transitions, responses to agent actions including rewards, etc. The AM system, AM device, and/or the ML model disclosed herein can be substantially similar in structure and/or function to the systems, devices and models disclosed in the U.S. patent application Ser. No. 17/902,455, entitled “APPARATUS AND METHODS TO PROVIDE A LEARNING AGENT WITH IMPROVED COMPUTATIONAL APPLICATIONS IN COMPLEX REAL-WORLD ENVIRONMENTS USING MACHINE LEARNING,” filed Sep. 2, 2022, the entire disclosure of which is incorporated here in its entirely for all purposes.

The integrated or hierarchical learning model illustrated in FIG. 9 can include multiple models that are each configured to simulate various levels of cognitive and/or behavioral functions including arousal states, emotive states, goals, attentional states, affordance, experiential states, etc. As an example, organized over the experiential model that provides actions that interact with the world, an HLS can use a model simulating emotions capable in an animal to enable the agent to select strategies that include sub-goals, state features to attend to, and action types the agent can execute within a particular context. This capability effectively reduces the strategy space in which the agent can act and can improve behavior selection while dramatically reducing reward variability over time. The hierarchical model can include a policy model that is configured to generate, modify, and/or learn to generate and modify policies on which an agent's interactions with an environment can be based. The hierarchical model can include an auto-tuning model that can be configured to implement adjustment of one or more parameters or hyperparameters of the policy model, a policy repertoire model that defines and/or creates more complex behaviors by combining world policy options, and an auto-tuning repertoire model that builds more complex hyperparameter configurations by combining auto-tuning options.

Using the hierarchical architecture of the cognitive model, the AM system can be configured to operate effectively even in new environments by automatically surveying the environment and automatically tuning hyperparameters based on results of agent interactions. The executive model of the Working Memory System (WMS) can provide memory and behavior replay management of the agent. Specifically, the WMS can orchestrate the internal/external generation of experience and replays to adaptively learn temporal abstractions and selection of potential behaviors for future execution. The cognitive model can thus provide a general-purpose AM system for state and action spaces used by the agent.

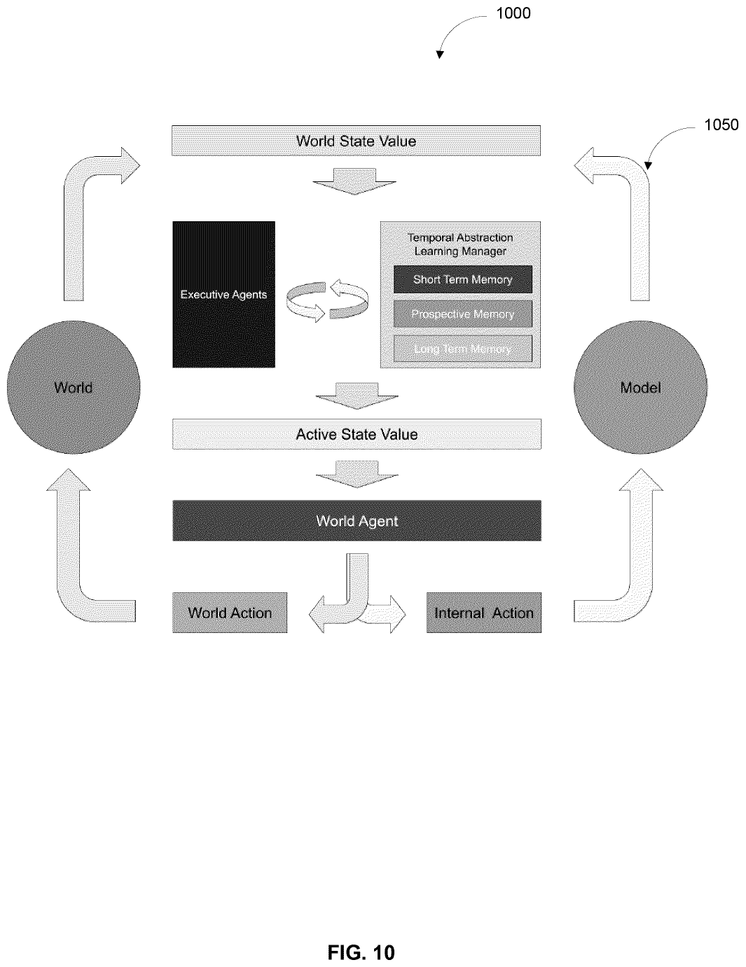

In some implementations, an AM system can operate by using a model to simulate an external world and an internal model to simulate an internal world or representation (e.g., an internal representation of an animal or a cohort of animals, etc.). The internal model can be associated with internal states that can be perceived, organized using a system of memory, and impacted via internal actions. The internal model can be configured to impact a world state value and in turn impact agent action/behavior. FIG. 10 is a flowchart 1050 schematically illustrating a flow of information in an AM system similar to the systems described above. The AM system included in the flow chart shows the two primary flows of information through the agent reasoning system. In the World flow path, on the left side in FIG. 10, the AM system selects behaviors that result in actions that are executed in the world. In the secondary path, to the right side in FIG. 10, the AM system interacts with its model of the world and is used for planning and creating options. In some implementations, the AM system can implement an ML model (e.g., ML model 457) that includes an executive model an example workflow of which is shown in FIG. 10. An executive model can be responsible for the management of content in an active memory associated with an agent. Active memory can support creating an agent and/or supporting the agent with performing complex behaviors. An AM system can implement a ML model by using one or more memory stores including, for example, short term memory, prospective memory, long-term memory, etc. which can, in some embodiments, be associated with a memory of an AM Device (e.g., memory 452 of AM device 405 in FIG. 4). The executive model can load the active memory (e.g., a system of active memory) from one of the multiple memory stores that include: Short-Term Memory, Prospective Memory and Long-Term Memory. The World Model is responsible for the selection of actions to be performed based on the active memory contents. The model in an AM system can receive information associated with a world state and its reward signal, which can impact interactions between executive model and the memory which leads to new behaviors. In some embodiments, the AM device (e.g., AM devices 105, 405) and/or the compute device (e.g., compute devices 101-102) of the AM system can include a temporal abstraction manager. In some implementations, for example, the temporal abstraction manager can be included in an agent manager (e.g., agent manager 456 of AM device 405 in FIG. 4). The temporal abstraction manager analyzes the changing contents of the memory system to discover new options and repertoire of options. Information associated with the value can be relayed to the world model, which can be translated into an agent's action in the external world, which can impact the world state, or an internal action that impacts an internal representation or internal model.

As an example, a model of the world can be a model of a cohort of animals managed in a group intended to produce milk to be purchased by manufacturers of cheeses. The world model can simulate states such as a cohort of animals at a current health status with a first average quality of milk, a first average yield of milk, a first duration of feed consumption, a first average amount of loss of production, a first average amount of waste of resources (e.g., in the form of leaked protein), etc. As an example, an internal model can be a model of an animal cohort that is in a similar state as the current world state. The internal model can simulate states of a cohort including lactation states in a lactation cycle, states of hunger, states of growth, etc. Each of the internal states can be configured to impact a world state and vice versa. The impact on the world state and/or the internal model can in turn result in a world state or world state transition, each of which can be associated with a value and used for planning by the AM system. The world state value can recursively impact the interactions between executive model, world model and the temporal abstraction manager.

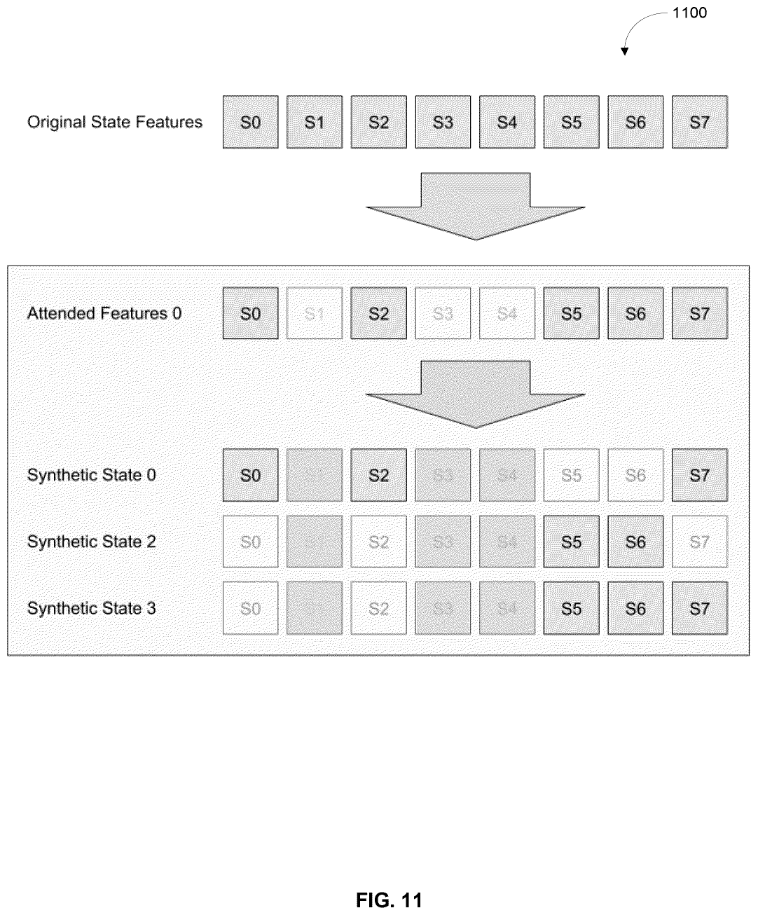

In some embodiments, the AM systems described herein can implement a Working Memory System (WMS) such that the WMS functions similar to a biological model and includes multiple subsystems that manage long term behavior selection, planning, and skill learning. In some implementations, an AM system can be configured such that the agent can interact not only in the world but also conceive states and/or state transitions or trajectories, or actions that are not experienced by the agent in the world. Such states conceived by agents can also be referred to as synthetic states, synthetic trajectories and synthetic actions imagined by agents. As part of the WMS, a processor of an AM device of the AM system can implement a Synthetic State & Trajectory Generation System (SSTGS) that is configured to manage generation of states and transition behavior for the agent's capability to conceive states/actions that are not experienced in the world (also referred to as the agents capability to imagine). FIG. 11 is a schematic illustration of generation of synthetic states by an AM system 1100, according to an embodiment. The AM system 1100 can be substantially similar in structure and/or function to the AM systems 100, 900, and/or systems FIGS. 2A, 2B, 3A, 3B, and/or 4, etc., and can implement methods similar to methods 500 and/or 600 described herein, and/or be implemented following the work flow 1050 illustrated in FIG. 10. In some embodiments, the synthetic state generation in the AM system 1100 can be implemented by an AM device substantially similar in structure and/or function to the AM devices 105, and/or 405, described herein.

Managed by the Executive Model, the agent, in the system 1100, can create and/or define synthetic trajectories to generate temporal abstractions that can be reused in the live environment. Derived from past actual experience, synthetic states and their transitions enable the agent to learn new sub-goals, attention and affordances from experience in an offline manner for example, when an environment has not been actually experienced by the agent. These behaviors and goals/attentional/affordances can serve as templates for future use and can improve agent performance.

As shown in FIG. 11, an ML model including an Executive Model can implement an environment or world that can include an original state or a source state (e.g., states S1, S2, S5, S6, and S7). An original state or source state can be used to generate one or more synthetic states. To create and/or define a synthetic state (SS) (e.g., synthetic states 0, 2, and 3), a new set of features can be selected using the features associated with the original state as the source (e.g., state features associated with states S1, S2, S5, S6, and S7). Actions can be generated from a subset of actions associated with one or more original states. The executive model can then estimate transition Q-values based on the average Q-values of the original state. Thus, synthetic state generation is achieved through the re-evaluation of an instant state's attended state features and its action space. The Executive Model (EM) selects new features to be associated with a state and creates and/or defines a new synthetic state with actions and reward values that can be based on the actions, rewards, and/or values associated with the source action value. The system is configured to generate synthetic states and can build targeted temporal abstraction candidates for the agent to use in the future and can accelerate agent learning of the environment through more effective use of its current experience.

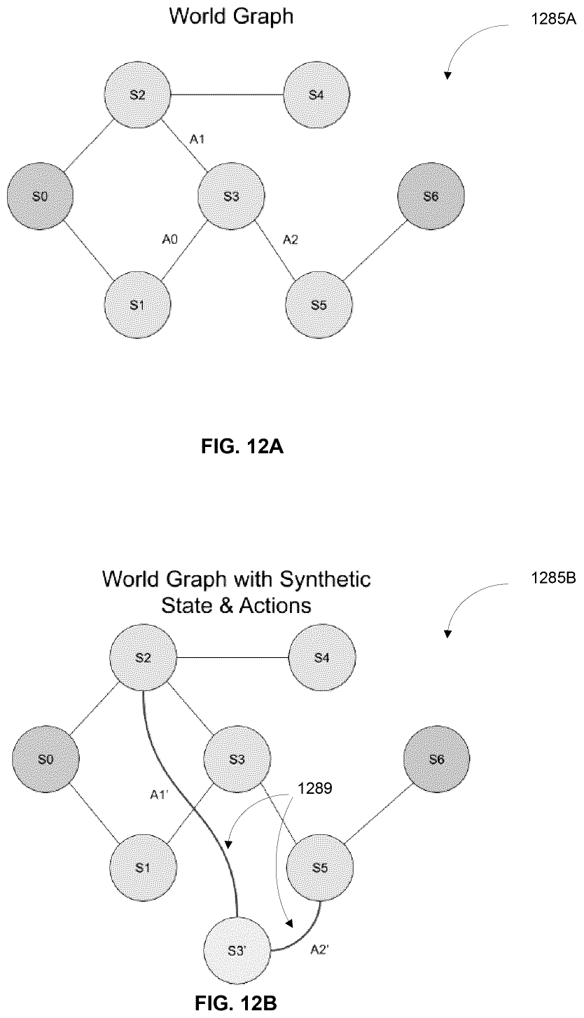

In addition to the creation and/or definition of synthetic states, a WMS can create and/or define synthetic trajectories based on the current model of the world. Through this the agent generates new temporal abstractions with estimated reward values. These skills are then tested in the real world and retained/discarded depending on the quality of the behavior. The creation and/or definition of targeted synthetic trajectories can conserve processing and memory use because creation and/or definition of targeted synthetic trajectories can be implemented in an offline and/or low priority process while the agent is executing an option in the world. Options allow the agent to execute preprogramed behaviors freeing the agent to allocate processing resources to planning and behavior generation through synthetic experience simulations. FIGS. 12A and 12B illustrate world graphs representing potential state transition trajectories without and with including synthetic trajectories 1289. In some implementations, synthetic states and/or synthetic trajectories can be included in temporal abstractions. In some implementations, synthetic states and synthetic trajectories can be learned to accomplish tasks in an improved manner in an environment or context that is reflected in a measure of performance. An agent can then use the synthetic state and/or trajectory when appropriate in another context or environment based on a current measure of performance.

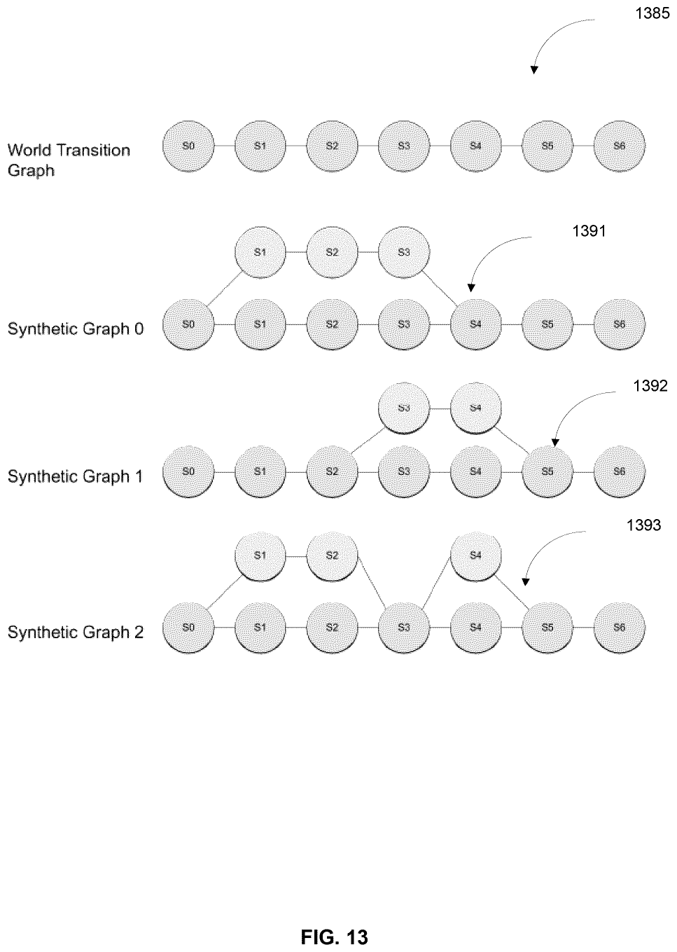

FIG. 13 illustrates an example world transition graph 1385 that is associated with a world simulated by an AM system according to an embodiment. FIG. 13 also illustrates three example synthetic graphs 1391, 1392, and 1393, representing temporal abstractions that include synthetic trajectories that allow transitions between states included in the graph 1385, but via synthetic states. The synthetic trajectories can be generated and implemented in a simulation by the AM system that can be similar to a synthetic experience or conceived/imagined by an agent in the AM system, according to an embodiment. Learning of temporal abstractions can have an exponential impact on agent learning of environments. Temporal abstractions learned in one environment or context can be made use of by an agent in another environment or context based on a measure of performance when the temporal abstraction was used and/or a measure of performance at a current time period. Additionally, the synthetic trajectories allow the agent to test different attentional and behavioral constraints that may prove to me more reliable in appraising and execution of behavior. An example of this can be the agent shifting the agent's attention to features associated to physical health such as somatic cell counts over milk fat content. This can then be adjusted by the agent to ensure that actions that change medicinal type are enabled in addition to feed type adjustment. In another scenario, the animal cohort can be in optimal and/or desired health and production quality based on which the system can create skills that prevent the use of medicinal treatments unnecessarily.

In some embodiments, similar to the generation of synthetic states/state transition trajectories, a subset of the action space of the parent state can be selected. An AM system can estimate action Q-values and adjust the estimated values using an executive model, allowing the executive model to update the value function of various simulated synthetic trajectories. Synthetic experience (including synthetic states/state transitions) can be implemented as a temporal abstraction that is stored as a volatile memory representation and trimmed from the agent's model over time. The trimming can be omitted when the agent encounters a portion of a synthetic trajectory or a portion of synthetic state in a temporal abstraction in a non-synthetic context or in a simulation of a world. When the agent experiences a synthetic experience in a real simulation of the world that synthetic experience can be made permanent and its value can be updated to match the actual return value in the real simulation or model.

In some embodiments, an AM system can be configured to implement a feature referred to as Adaptive Lookahead which can be implemented as a part of the WMS. The Adaptive Lookahead System (ALS) can be an Executive Model (EM) controlled function that performs contextually relevant lookaheads from current or expected future states to guide behavior selection. Similar to Monte Carlo methods, ALS can provide an agent the ability to optimize and/or improve the use of lookahead for the agent. This system balances internal simulation time and live behavior to improve agent computational needs while providing improved action selection through experience search. Managed by the EM, the agent is configured to learn how to optimize this process minimizing its computational load with improved reward gains over time.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made.

Although various embodiments have been described as having particular features and/or combinations of components, other embodiments are possible having a combination of any features and/or components from any of embodiments as discussed above.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

In this disclosure, references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The use of any and all examples, or exemplary language (“e.g.,” “such as,” “including,” or the like) provided herein, is intended merely to better illuminate the embodiments and does not pose a limitation on the scope of the embodiments or the claims.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method, comprising:
receiving information associated with interactions of an agent with an environment, the interactions including a plurality of states associated with the environment and a plurality of actions associated with each state from the plurality of states, the interactions being according to a policy defined based on a plurality of hyperparameters;
receiving an indication of a target state to be achieved by the agent in the environment;
determining an indication of a set of current values, each current value from the set of current values being associated with a different hyperparameter from the plurality of hyperparameters, the plurality of hyperparameters being configured to impact the agent's interactions with the environment; and
modifying the policy by automatically changing at least one current value from the set of current values based on the information associated with the interactions of the agent with the environment and the indication of the target state to increase a likelihood of the agent achieving the target state or maximizing gain of rewards over time.

2. The method of claim 1, wherein the modifying the policy by automatically changing the at least one current value from the set of current values is done by the agent without an involvement of a user.

3. The method of claim 1, wherein the plurality of hyperparameters includes at least one of lambda indicating a learning rate, gamma indicating a measure of discount of future rewards, or epsilon indicating a coefficient of greediness in the agent's interactions with the environment.

4. The method of claim 1, wherein the policy is a first policy, the method further comprising:
determining a first measure of performance associated with interactions of the agent with the environment, the first measure of performance being based on the agent's interactions with the environment according to the first policy;
determining a second measure of performance associated with interactions of the agent with the environment, the second measure of performance being based on the agent's interactions with the environment according to a second policy different than the first policy; and
calculating a difference between the first measure of performance and the second measure of performance, the changing at least one current value from the set of current values being based on the difference.

5. The method of claim 4, wherein the first measure of performance and the second measure of performance are at least one of a measure of rewards received in the course of the interactions of the agent with the environment or a measure of quality perceived by the agent in the course of the interactions of the agent with the environment.

6. The method of claim 4, wherein the second policy is associated with greedy interactions of the agent with the environment.

7. The method of claim 4, further comprising:
computing a measure of variance associated with the first measure of performance associated with the interactions of the agent with the environment; and
adjusting the difference between the first measure of performance and the second measure of performance based on the measure of variance, the changing at least one current value from the set of current values being based on the difference after the adjusting.

8. The method of claim 7, wherein the adjusting the difference between the first measure of performance and the second measure of performance based on the measure of variance includes computing a ratio of the difference between the first measure of performance and the second measure of performance and the measure of variance.

9. The method of claim 6, wherein the first measure of performance is an expected value of rewards associated with the agents interactions with the environment according to the first policy and the second measure of performance is an expected value of rewards associated with the agent's interactions with the environment according to the second policy, the method further comprising:
computing a standard deviation associated with the rewards associated with the agent's interactions with the environment according to the first policy; and
computing a Sharpe ratio of a difference the first measure of performance and the second measure of performance and the standard deviation associated with the rewards associated with the agent's interactions with the environment according to the first policy, the modifying the policy by automatically changing at least one current value from the set of current values being based on the Sharpe ratio.

10. The method of claim 4, wherein the first measure of performance and the second measure of performance are at least one of a measure of rewards received in the course of the interactions of the agent with the environment or a measure of quality perceived by the agent in the course of the interactions of the agent with the environment.

10. The method of claim 1, wherein the information associated with interactions of the agent with the environment includes a context associated with the environment, the context indicating a non-stationary nature of the environment.

11. The method of claim 10, wherein the environment is a first environment, the method further comprising:
retrieving context associated with a second environment different from the first environment, the context associated with the second environment indicating a non-stationary nature of the second environment; and
comparing the context associated with the first environment with the context associated with the second environment, the modifying the policy by changing at least one current value from the set of current values being based on the comparing.

12. The method of claim 4, wherein the first measure of performance and the second measure of performance are based on the agent's interactions with the environment in a predetermined first time period, the difference between the first measure of performance and the second measure of performance being a first difference, the method further comprising:
determining a third measure of performance associated with interactions of the agent with the environment, the third measure of performance being based on the agent's interactions with the environment according to a third policy different than the second policy, the agent's interactions with the environment being in a predetermined second time period different than the first time period;
determining a fourth measure of performance associated with interactions of the agent with the environment, the fourth measure of performance being based on the agent's interactions with the environment according to the second policy and in the predetermined second time period;
calculating a second difference between the third measure of performance and the fourth measure of performance; and
comparing the second difference with the first difference, the changing at least one current value from the set of current values being based on the comparing.

13. An apparatus, comprising:
a memory; and
a hardware processor operatively coupled to the memory, the hardware processor configured to:
determine a first measure of performance associated with interactions of an agent with an environment, the first measure of performance being based on the agent's interactions with the environment according to a first policy;
determine a second measure of performance associated with interactions of the agent with the environment, the second measure of performance being based on the agent's interactions with the environment according to a second policy different than the first policy;
calculate a difference between the first measure of performance and the second measure of performance; and
automatically change, based on the difference between the first measure of performance and the second measure of performance, at least one current value from a set of current values, each current value from the set of current values being associated with a different hyperparameter from a plurality of hyperparameters, the plurality of hyperparameters being configured to impact the agent's interactions with the environment.

14. The apparatus of claim 13, wherein the plurality of hyperparameters includes epsilon which indicates a coefficient of greediness associated with interactions of the agent with the environment, and the second measure of performance is based on interactions of the agent with the environment according to the second policy in which epsilon is indicated to be below a predefined threshold value.

15. The apparatus of claim 13, wherein the first measure of performance and the second measure of performance are at least one of a measure of rewards received in the course of the interactions of the agent with the environment or a measure of quality perceived by the agent in the course of the interactions of the agent with the environment.

16. The apparatus of claim 13, wherein the first measure of performance is a rate of rewards over a predetermined time period in a recent history of the agent's interactions with the environment according to the first policy, and the second measure of performance is a rate of rewards over the predetermined time period in the recent history of the agent's interactions with the environment according to the second policy.

17. The apparatus of claim 13, wherein the hardware processor is further configured to:
determine a measure of variance associated with the first measure of performance associated with interactions of the agent with the environment;
compute a ratio of (1) the difference between the first measure of performance and the second measure of performance and (2) the measure of variance; and
change the at least one current value from the set of current values based on the ratio.

18. The apparatus of claim 17, wherein the hardware processor is configured to change the at least one current value from the set of current values such that the ratio is increased towards a target value.

19. The apparatus of claim 13, wherein the agent is a first agent and the hardware processor is further configured to:
implement a second agent different than the first agent, the second agent configured to automatically perform the determining the first measure of performance, the determining the second measure of performance, and the changing of at least one current value from a set of current values.

20. The apparatus of claim 13, wherein the plurality of hyperparameters includes at least one of lambda indicating a learning rate, gamma indicating a measure of discount of future rewards, or epsilon indicating a coefficient of greediness in the agent's interactions with the environment.

21. A non-transitory processor-readable medium storing code representing instructions to be executed by a processor, the instructions comprising code to cause the processor to:
receive data associated with interactions between a first agent and a first environment, the data including a context associated with the first environment;
receive information about a second environment, the information including a goal that is desired to be achieved in the second environment;
implement, using a machine learning model, a second agent configured to interact with the second environment according to a policy;
receive information associated with interactions of the second agent with the second environment, the information including a context of the second environment and one or more measures of performance associated with the interactions of the second agent with the second environment; and
modify the policy, based on the data associated with the interactions between the first agent and the first environment, by changing at least one current value from a set of current values, each current value from the set of current values being associated with a different hyperparameter from a plurality of hyperparameters, the plurality of hyperparameters being configured to impact the second agent's interactions with the second environment.

22. The non-transitory processor-readable medium of claim 21, wherein the plurality of hyperparameters includes at least one of lambda indicating a learning rate, gamma indicating a measure of discount of future rewards, or epsilon indicating a coefficient of greediness in the second agent's interactions with the second environment.

23. The non-transitory processor-readable medium of claim 21, wherein the context associated with the first environment indicates a first non-stationary nature based on varying reward expectations associated with known actions, the first non-stationary nature being associated with the first environment, and the context associated with the second environment indicates a second non-stationary nature based on varying reward expectations associated with known actions, the second non-stationary nature being associated with the second environment, the first non-stationary nature being related to the second non-stationary nature.

24. The non-transitory processor-readable medium of claim 21, wherein the interactions of the second agent with the second environment include (i) a first set of interactions based on a first policy defined at least in part by the set of current values associated with the plurality of hyperparameters; and (ii) a second set of interactions based on a second policy different than the first policy and defined at least in part by at least one current value from the set of current values associated with the plurality of hyperparameters being above a threshold value.

25. The non-transitory processor-readable medium of claim 24, wherein the one or more measures of performance includes (i) a first performance of rewards received over a predetermined period of time based on the first set of interactions; and (ii) a second measure of performance received over the predetermined period of time based on the second set of interactions, the predetermined period of time being defined in a history of interactions of the second agent with the second environment.

26. The non-transitory processor-readable medium of claim 24, wherein the at least one current value from the set of current values that is above the threshold value is associated with epsilon, which is a hyperparameter from the plurality of hyperparameters and indicates a coefficient of greediness in the second agent's interactions with the second environment.

27. The non-transitory processor-readable medium of claim 24, wherein the instructions comprising code to cause the processor to implement the second agent to perform the action include code to cause the processor to store a configuration including data associated with the first set of interactions based on the first policy, the second set of interactions based on the second policy, and the set of current values associated with the plurality of hyperparameters.
